(19) United States
(12) Patent Application Publication
(10) Pub. No.: US 2011/0280189 A1
(43) Pub. Date: Nov. 17, 2011

(54) BASE STATION APPARATUS, MOBILE STATION APPARATUS, AND MOBILE COMMUNICATION SYSTEM

(75) Inventors: Hidekazu Tsuboi, Osaka (JP); Katsunari Uemura, Osaka (JP); Toshizo Nogami, Osaka (JP)

(73) Assignee: SHARP KABUSHIKI KAISHA, Osaka-shi, Osaka (JP)

(21) Appl. No.: 13/146,264

(22) PCT Filed: Jan. 6, 2010
(86) PCT No.: PCT/JP2010/050070

§ 371 Date: Aug. 5, 2011

(30) Foreign Application Priority Data
Jan. 27, 2009 (JP) 2009-015912

(51) Int. Cl. H04W 4/00

(52) U.S. Cl. 370/328

(57) ABSTRACT

To keep PAPR low even when the same physical cell ID is used in each component carrier, a base station apparatus 100 for combining a plurality of component carriers to transmit has phase rotation sections 105-1 to 105-n that provide phase rotation for each component carrier, and a transmission section 108 that transmits the component carriers provided with phase rotation to a mobile station apparatus, where the phase rotation amount is determined based on a physical cell ID common to component carriers.

### TECHNICAL FIELD

The present invention relates to a base station apparatus, mobile station apparatus and mobile communication system for performing wireless communications using a multicarrier communication scheme.

### BACKGROUND ART

Conventionally, Evolution (Evolved Universal Terrestrial Radio Access; hereinafter, referred to as “EUTRA”) of 3rd Generation (hereinafter, referred to as “3G”) radio access scheme of cellular mobile communication, and Evolution (Evolved Universal Terrestrial Radio Access Network; hereinafter, referred to as “EUTRAN”) of 3G network have been studied in 3GPP (3rd Generation Partnership Project).

Further, 3GPP started studies on the 4th Generation (hereinafter, referred to as “4G”) radio access scheme (Advanced EUTRA; hereafter, referred to as “A-EUTRA” or “LTE-A”) of cellular mobile communication, and 4G network (Advanced EUTRAN; hereinafter, referred to as “A-EUTRAN”). In A-EUTRA, studies are made on support for wider bands than in EUTRA and compatibility with EUTRA, and it is proposed that a base station apparatus of A-EUTRA communicates with a mobile station apparatus of EUTRA in each frequency band (hereinafter, referred to as a “component carrier”) obtained by dividing a frequency band of A-EUTRA into a plurality of bands. In other words, it is proposed that a plurality of component carriers is provided with the function capable of transmitting a channel with the same configuration as in EUTRA.

In EUTRA, it has been determined that an OFDMA (Orthogonal Frequency Division Multiple Access) scheme which is tolerant of multipath interference and suitable for high-speed transmission is adopted as a downlink communication scheme. Further, in the cellular mobile communication scheme, since a mobile station apparatus receives signals transmitted from a base station apparatus in a cell or sector that is a communication area of the base station apparatus, it is necessary to acquire synchronization with a slot and a frame in a radio frame of the base station apparatus. The base station apparatus transmits a synchronization channel SCH comprised of a defined configuration, and the mobile station apparatus calculates correlation with a beforehand stored synchronization channel SCH to detect the synchronization channel SCH, and thus acquires synchronization with the base station apparatus. In EUTRA, a primary synchronization channel P-SCH (Primary SCH) and secondary synchronization channel S-SCH (Secondary SCH) are assumed as a synchronization channel SCH.

FIG. 6 is a diagram showing an example of a configuration of a radio frame in EUTRA. In FIG. 6, the horizontal axis represents the time axis, while the vertical axis represents the frequency axis. In a radio frame, 12 subcarriers (sc) on the frequency axis and a slot that is a set of a plurality of OFDM symbols on the time axis are configured as a unit, and a region split by 12 subcarriers and one slot length is called a resource block (Non-patent Document 1). Two grouped slots are called a sub-frame, and further, ten grouped sub-frames are called a frame. A plurality of resource blocks is arranged consecutively in the frequency domain, and 100 resource blocks are arranged in a bandwidth of 20 MHz (BW=20 MHz). To prevent radiation to adjacent bands, guard bands where signals are not transmitted are arranged at the opposite ends.

Sub-frames #0 and #5 include the P-SCH, S-SCH and broadcast information channel as described previously, and the mobile station apparatus calculates correlation of a reception signal with replica signals of a plurality of sequences of the primary synchronization channel P-SCH in the time domain, thereby establishes slot synchronization (step 1), further calculates correlation of a reception signal with a plurality of replica signals of the secondary synchronization channel S-SCH in the time domain or frequency domain, and establishes frame synchronization using the sequence of the obtained secondary synchronization channel S-SCH, while identifying a physical cell ID (Identification: identification information) Nid (0≦Nid≦503) to identify the base station apparatus also using the sequence of the P-SCH that is previously detected (step 2). The aforementioned two steps are called a cell search procedure. Subsequently, the mobile station apparatus demodulates the broadcast information channel, and is thereby capable of acquiring primary parameters such as the number of transmission antenna ports.

FIGS. 7A to 7C are diagrams showing details of a single resource block. FIGS. 7A to 7C show positions of reference signals (also referred to as pilot signals) of each antenna port when the number of transmission antenna ports is “1”, “2” or “4”, respectively. The reference signal is a known signal used in demodulating a signal, and a usage sequence and arrangement pattern are uniquely designated by physical cell ID Nid of the base station apparatus. FIG. 7A shows the arrangement when (Nid mod 6)=0, and when (Nid mod 6)=S, positions are shifted regularly inside the resource block by S subcarriers from the arrangement of FIG. 7A in the direction in which frequencies are higher.

FIG. 8 contains diagrams selectively showing only arrangements of antenna port 1 when the number of antenna ports is “4”. As shown in FIG. 8, in any physical cell ID, a reference signal RS1 of the first antenna (Ant 1) and reference signal RS2 of the second antenna (Ant 2) are mapped to the first and fifth OFDM symbols in the resource block, and a reference signal RS3 of the third antenna and reference signal RS4 of the fourth antenna are mapped to the second OFDM symbol.

Each component carrier of A-EUTRA has the frame structure of EUTRA as shown in FIG. 6 described above, and therefore, the frame structure of A-EUTRA in which component carriers are consecutively arranged is as shown in FIG. 9. In addition, herein, the arrangement includes guard bands of each component carrier, but it is also possible to remove the guard band when component carriers are consecutively arranged. In the frame configuration of A-EUTRA in FIG. 9, signals are transmitted from the base station apparatus of A-EUTRA.

FIG. 10 is a diagram illustrating a schematic configuration of the base station apparatus of A-EUTRA. The base station apparatus 1000 performs coding of transmission data for each component carrier in coding sections 101-1 to 101-n. Further, the apparatus modulates the coded signals in modulation sections 102-1 to 102-n. Furthermore, the apparatus generates synchronization channels and reference signals in SCH/RS generating sections 103-1 to 103-n, based on the physical cell ID (common to all component carriers) and generation timing notified from a control section, described later.

Multiplexing sections 104-1 to 104-n multiplex signals modulated in the modulation sections 102-1 to 102-n, and the synchronization channels and reference signals generated in the SCH/RS generating sections 103-1 to 103-n on an OFDM-symbol basis. The component carrier multiplexing section 106 maps a signal corresponding to a single OFDM symbol multiplexed in the multiplexing sections 104-1 to 104-n for each component carrier to the frequency region as shown in FIG. 9. A frequency/time transform section 107 transforms the signal in the frequency domain multiplexed in the component carrier multiplexing section 106 into a signal in the time domain by IFFT computing. A transmission section 108 converts the digital signal that is transformed into the signal in the time domain into an analog signal, places the signal on a carrier wave of a predetermined frequency to perform power amplification, and transmits the signal. In addition, the above-mentioned coding section 101-1 to transmission section 108 constitute a transmission processing section.

Meanwhile, the base station apparatus 1000 converts a signal received from a mobile station apparatus into a digital baseband signal in a reception section 110. Further, the base station apparatus 1000 demodulates signals in demodulation sections 111-1 to 111-n for each component carrier, and decodes the demodulated signals in decoding sections 112-1 to 112-n. In addition, the above-mentioned reception section 110 to decoding section 112-n constitute a reception processing section.

The control section 113 controls each component of the above-mentioned transmission processing section and reception processing section. An upper layer 115 outputs a transmission signal to the above-mentioned transmission processing section, receives a reception signal from the reception processing section, and outputs control information to the control section 113. By using such a base station apparatus 1000, signals of EUTRA are generated in the coding sections 101-1 to 101-n, modulation sections 102-1 to 102-n, SCH/RS generating sections 103-1 to 103-n, and multiplexing sections 104-1 to 104-n for each component carrier, and the signals of respective component carriers are aggregated in the component carrier multiplexing section 106, and transmitted as a signal of A-EUTRA.

Herein, to efficiently use power amplification performed in the transmission section 108 in the base station apparatus 1000, it is generally desirable to reduce the Peak to Average Power Ratio (PAPR) of a transmission signal to a low level. Since each component carrier has a different frequency band, the physical cell ID of each component carrier may be a different ID or the same ID.

However, since the reference signal described previously is uniquely generated from the physical cell ID, when the same ID is used in each component carrier, as shown in FIG. 9, the same signal is inserted periodically in OFDM symbols of A-EUTRA including the reference signal. When the same signal is inserted periodically in OFDM signal generation, there is a characteristic that the PAPR increases as the number of times the signal is periodically inserted increases.

Therefore, in Non-patent Document 2, it is proposed that a different ID is used in each component carrier to prevent the same signal from being inserted periodically, and that the PAPR is thereby kept low (Non-patent Document 2 uses Cubic Metric (CM) that is the same indicator as the PAPR.)

The following table shows an example of CM values of OFDM symbols including reference signals in the case of using the same physical cell ID in component carriers of n=1 to 5, and CM values in the case of using different physical cell IDs. In addition, as the conditions, “0” is used as the same physical cell ID, and “0”, “1”, “2” “3”, and “4” are used as different physical cell IDs. Further, a single transmission antenna is used, and the signal power other than the reference signal is set at “0”.

TABLE 1

| | n = 1 | n = 2 | n = 3 | n = 4 | n = 5 |
|---|---|---|---|---|---|
| Same | 4.00 | 6.55 | 8.53 | 10.14 | 11.43 |
| Physical | | | | | |
| Cell ID | | | | | |
| Different | 4.00 | 3.75 | 3.81 | 3.92 | 3.93 |
| Physical | | | | | |
| Cell ID | | | | | |

As shown in the aforementioned table, it is confirmed that the CM is kept low by allocating different physical cell IDs to component carriers.

### PRIOR ART DOCUMENT

### Patent Document

Patent Document 1: Japanese Unexamined Patent Publication NO. 2006-165781

### Non-Patent Document

Non-patent Document 1: 3GPP TS36.213, V8.3.0 (2008 May),Technical Specification Group Radio Access Network; Evolved Universal Terrestrial Radio Access (E-UTRA); Physical layer procedures (Release 8). http://www.3gpp.org/ftp/Specs/html-info/36213.htm
Non-patent Document 2: 3GPP TSG RAN WG1 #55, R1-084195, “Issues on the physical cell ID allocation to the aggregated component carriers”, LG Electronics
Non-patent Document 3: 3GPP TSG RAN WG1 #55, R1-084196, “Initial Access Procedure in LTE-Advanced”, LG Electronics
Non-patent Document 4: 3GPP TSG RAN WG1 #55bis, R1-090281, “Resolving CM and Cell ID Issues Associated with Aggregated Carriers”, Texas Instruments

### DISCLOSURE OF INVENTION

### Problems to be Solved by the Invention

However, when a mobile station apparatus of A-EUTRA is assigned resources of a plurality of component carriers, the apparatus needs to perform processing dependent on the physical cell ID for each component carrier, for example, scramble release of the downlink signal, identification of the position and code of the reference signal, etc. and as shown in Non-patent Document 1, when different physical cell IDs are used for each component carrier, needs to perform processing varying with component carriers. In contrast thereto, when the same physical cell ID is used for each component carrier, the apparatus is capable of performing the common processing for each component carrier, and it is possible to simplify the processing.

Further, as shown in Non-patent Document 3, in the case that downlink and uplink are not in a one-to-one correspondence with each other, and that a single uplink is shared among a plurality of downlinks (in Asymmetric Carrier aggregation), the correspondence is made ease by giving the same physical cell ID to downlink component carriers sharing the uplink.

Furthermore, in Patent Document 1, the information is divided into clusters to perform phase control on a cluster basis, it is thereby intended to reduce the PAPR, but any method suitable for A-EUTRA is not described. Moreover, in Non-patent Document 4, it is proposed to reduce the CM by performing predetermined sign inversion for each component carrier corresponding to the number of aggregated component carriers.

The invention was made in view of such circumstances, and it is an object of the invention to provide a base station apparatus, mobile station apparatus and mobile communication system for enabling the PAPR to be kept low even when the same physical cell ID is used in all or part of component carriers.

### Means for Solving the Problem

(1) To achieve the above-mentioned object, the invention took measures as described below. In other words, a base station apparatus of the invention is a base station apparatus that combines a plurality of component carriers to transmit, and is characterized by having a phase rotation section that provides phase rotation for each component carrier, and a transmission section that transmits the component carrier provided with the phase rotation to a mobile station apparatus, where an amount of the phase rotation is determined based on a physical cell ID common to component carriers.

Thus, phase rotation is provided for each component carrier, the phase rotation amount is determined based on the physical cell ID common to component carriers, and therefore, even when the same physical cell ID is used in component carriers, it is possible to maintain compatibility with EUTRA while suppressing increases in PAPR (CM), and to perform propagation path compensation in A-EUTRA. By this means, it is possible to make power amplification in the transmission section efficient. Further, when the mobile station apparatus performs the processing (for example, scramble release of the downlink signal, identification of the position and code of the reference signal, etc.) dependent on the physical cell ID, the mobile station apparatus is capable of performing the common processing for each component carrier, and it is possible to simplify the processing. Furthermore, also at the time of Asymmetric Carrier aggregation, it is possible to provide downlink component carriers sharing uplink with the same physical cell ID.

(2) Further, the base station apparatus of the invention is characterized by further having a physical cell ID/phase rotation amount correspondence table that associates a phase rotation amount which is beforehand set based on a CM (Cubic Metric) value with the physical cell ID, where the phase rotation section provides phase rotation for each component carrier based on the physical cell ID/phase rotation amount correspondence table.

Thus, the base station apparatus is further provided with the physical cell ID/phase rotation amount correspondence table that associates an amount of phase rotation which is beforehand set based on a CM (Cubic Metric) value with the physical cell ID, the phase rotation section provides phase rotation for each component carrier based on the physical cell ID/phase rotation amount correspondence table, and it is thereby possible to use an optimal phase rotation amount for each physical cell ID, and to make the processing efficient.

(3) Furthermore, the base station apparatus of the invention is characterized in that the phase rotation section has a sign inverting section that inverts the sign, and a replacing section that replaces a real part and an imaginary part of an input signal with each other.

Thus, the phase rotation section is provided with the sign inverting section that inverts the sign, and the replacing section that replaces a real part and an imaginary part of an input signal with each other, and it is thereby possible to simplify the equipment configuration (circuit configuration), and to maintain good PAPR characteristics.

(4) Moreover, a base station apparatus of the invention is a base station apparatus that combines a plurality of component carriers to transmit, and is characterized by having a phase rotation section that provides phase rotation for each component carrier, a CM calculating section that calculates a CM value when a physical cell ID is changed in any one of the component carriers, a control section that sets the phase rotation section for an amount of phase rotation based on the CM value, and a transmission section that transmits the component carrier provided with the phase rotation to a mobile station apparatus.

Thus, the base station apparatus provides phase rotation for each component carrier, calculates a CM value when the physical cell ID is changed in any one of the component carriers, and sets the phase rotation section for a phase rotation amount based on the CM value, and therefore, even when the physical cell ID of the component carrier is set and changed individually, it is possible to make power amplification in the transmission section efficient.

(5) Further, the base station apparatus of the invention is characterized in that the CM value is a value when a transmission signal is a reference signal of each component carrier, primary synchronization channel, secondary synchronization channel, broadcast information channel or a combination thereof.

Thus, the CM value is a value when a transmission signal is a reference signal of each component carrier, primary synchronization channel, secondary synchronization channel, broadcast information channel or a combination thereof, and it is made ease grasping the phase rotation amount such that the CM value is optimal. In other words, when data except the reference signal is included, data varies with component carriers, and the CM value is thereby a good value, but only in the value, there is a case that it is difficult to grasp the effect of providing the phase rotation. Therefore, the CM value is used when a transmission signal is a reference signal of each component carrier, primary synchronization channel, secondary synchronization channel, broadcast information channel or a combination thereof.

(6) Moreover, a base station apparatus of the invention is a base station apparatus that combines a plurality of component carriers to transmit, and is characterized by having a phase rotation section that provides phase rotation for each component carrier, and a transmission section that transmits the component carrier provided with the phase rotation to a mobile station apparatus, where an amount of the phase rotation is determined based on a physical cell ID, while being changed based on the physical cell ID at certain time intervals.

Thus, since the phase rotation amount is determined based on the physical cell ID, while being changed based on the physical cell ID at certain time intervals, signals of adjacent cells (having different physical cell IDs) rotate in phase independently of each other with time, and it is possible to randomize interference.

(7) Further, the base station apparatus of the invention is characterized by further having a physical cell ID/phase rotation amount correspondence table that associates the physical cell ID with each amount of phase rotation of the component carrier, and a physical cell ID/phase rotation offset amount correspondence table that associates the physical cell ID with a phase rotation offset amount in the time domain to store, where the phase rotation section provides phase rotation for each component carrier based on the physical cell ID/phase rotation amount correspondence table and the physical cell ID/phase rotation offset amount correspondence table.

Thus, the base station apparatus is further provided with the physical cell ID/phase rotation amount correspondence table that associates the physical cell ID with each phase rotation amount of the component carrier, and the physical cell ID/phase rotation offset amount correspondence table that associates the physical cell ID with a phase rotation offset amount in the time domain to store, the phase rotation section performs phase rotation for each component carrier based on the physical cell ID/phase rotation amount correspondence table and the physical cell ID/phase rotation offset amount correspondence table, signals of adjacent cells (having different physical cell IDs) thereby rotate in phase independently of each other with time, and it is possible to randomize interference and make the processing efficient.

(8) Furthermore, the base station apparatus of the invention is characterized by changing a basis for the amount of the phase rotation corresponding to the number of component carriers to combine.

Thus, since the basis for the phase rotation amount is changed corresponding to the number of aggregated component carriers, it is possible to enhance PAPR (CM) characteristics while suppressing increases in the circuit scale.

(9) Further, a mobile station apparatus of the invention is a mobile station apparatus that performs wireless communications with the above-mentioned base station apparatus, and is characterized by providing a signal received from the base station apparatus with inverse phase rotation to phase rotation provided in the base station apparatus.

Thus, the mobile station apparatus provides a signal received from the base station apparatus with inverse phase rotation to phase rotation provided in the base station apparatus, and is thereby capable of performing propagation path compensation with high accuracy. By this means, for example, when a mobile station apparatus of A-EUTRA performs propagation path compensation exceeding the period of count-up, the mobile station apparatus removes a phase rotation offset added in the base station apparatus before the propagation path compensation section, and is thereby capable of performing propagation path compensation with high accuracy.

(10) Furthermore, the mobile station apparatus of the invention is characterized by providing the inverse phase rotation based on an amount of phase rotation that is beforehand notified from the base station apparatus using an upper control signal.

Thus, the mobile station apparatus provides the inverse phase rotation based on an amount of phase rotation that is beforehand notified from the base station apparatus using an upper control signal, thereby restores the phase rotation added in the base station apparatus by inverse phase rotation based on the notified phase rotation amount, and is capable of performing propagation path compensation across component carriers.

(11) Still furthermore, the mobile station apparatus of the invention is characterized by having a phase difference determining section that determines an amount of phase rotation of each component carrier from a phase difference between adjacent component carriers, and providing the inverse phase rotation based on the amount of phase rotation determined in the phase difference determining section.

Thus, the mobile station apparatus determines the phase rotation amount of each component carrier from the phase difference between adjacent component carriers, restores the phase rotation added in the base station apparatus by inverse phase rotation based on the determined phase rotation amount, and is capable of performing propagation path compensation across component carriers.

(12) Moreover, a mobile station apparatus of the invention is a mobile station apparatus that performs wireless communications with the above-mentioned base station apparatus, and is characterized by having a physical cell ID/phase rotation amount correspondence table that associates an amount of phase rotation that is beforehand set based on a CM value with the physical cell ID, acquiring an amount of phase rotation from the physical cell ID/phase rotation amount correspondence table, and a physical cell ID of a base station apparatus to connect, and providing a signal received from the base station apparatus with inverse phase rotation to phase rotation provided in the base station apparatus.

Thus, the mobile station apparatus acquires an amount of phase rotation from the physical cell ID/phase rotation amount correspondence table, and a physical cell ID of a base station apparatus to connect, thereby restores the phase rotation added in the base station apparatus by inverse phase rotation based on the acquired phase rotation amount, and is capable of performing propagation path compensation across component carriers.

(13) Further, a mobile station apparatus of the invention is a mobile station apparatus that performs wireless communications with the above-mentioned base station apparatus, and is characterized by providing a signal received from the base station apparatus with inverse phase rotation to phase rotation provided in the base station apparatus on a basis for an amount of phase rotation corresponding to the number of combined component carriers.

Thus, the mobile station apparatus provides a signal received from the base station apparatus with inverse phase rotation to phase rotation provided in the base station apparatus on a basis of the amount of phase rotation corresponding to the number of aggregated component carriers, and is thereby capable of decreasing determination errors in determining the amount of phase rotation.

(14) Moreover, a mobile communication system of the invention is characterized by being comprised of any one of base station apparatuses described above, a mobile station apparatus supporting EUTRA (Evolved Universal Terrestrial Radio Access), and a mobile station apparatus supporting A-EUTRA (Advanced EUTRA).

According to this configuration, phase rotation is provided for each component carrier, the phase rotation amount is determined based on a physical cell ID common to component carriers, and therefore, even when the same physical cell ID is used in the component carriers, it is possible to maintain compatibility with EUTRA while suppressing increases in PAPR (CM), and perform propagation path compensation in A-EUTRA. By this means, it is possible to make power amplification in the transmission section efficient. Further, when the mobile station apparatus performs the processing (for example, scramble release of the downlink signal, identification of the position and code of the reference signal, etc.) dependent on the physical cell ID, the mobile station apparatus is capable of performing the common processing for each component carrier, and it is possible to simplify the processing. Furthermore, also at the time of Asymmetric Carrier aggregation, it is possible to provide downlink component carriers sharing uplink with the same physical cell ID.

### Advantageous Effect of the Invention

According to the invention, phase rotation is provided for each component carrier, the phase rotation amount is determined based on a physical cell ID common to component carriers, and therefore, even when the same physical cell ID is used in the component carriers, it is possible to maintain compatibility with EUTRA while suppressing increases in PAPR (CM), and perform propagation path compensation in A-EUTRA. By this means, it is possible to make power amplification in the transmission section efficient. Further, when the mobile station apparatus performs the processing (for example, scramble release of the downlink signal, identification of the position and code of the reference signal, etc.) dependent on the physical cell ID, the mobile station apparatus is capable of performing the common processing for each component carrier, and it is possible to simplify the processing. Furthermore, also at the time of Asymmetric Carrier aggregation, it is possible to provide downlink component carriers sharing uplink with the same physical cell ID. Moreover, also when physical cell IDs of part of component carriers are different IDs, it is similarly possible to maintain compatibility with EUTRA while suppressing increases in PAPR (CM), and to perform propagation path compensation in A-EUTRA.

### BRIEF DESCRIPTION OF DRAWINGS

FIG. 1 is a block diagram illustrating a schematic configuration of a base station apparatus according to this Embodiment;

FIG. 2A is a block diagram illustrating a schematic configuration of a base station apparatus according to Embodiment 2;

FIG. 2B is a block diagram illustrating a schematic configuration of a phase rotation section;

FIG. 3 is a block diagram illustrating a schematic configuration of a base station apparatus according to Embodiment 3;

FIG. 4 is a block diagram illustrating a schematic configuration of a base station apparatus according to this Embodiment;

FIG. 5 is a diagram illustrating a schematic configuration of a reception processing section of an A-EUTRA mobile station apparatus according to this Embodiment;

FIG. 6 is a diagram showing an example of a configuration of a radio frame in EUTRA;

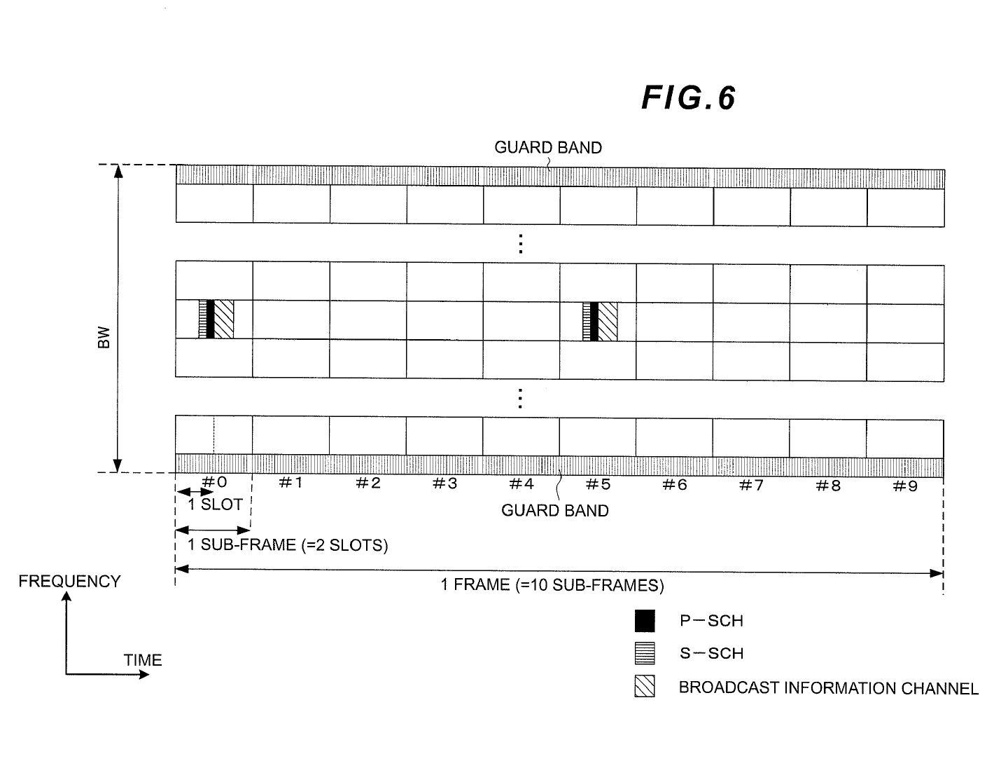

FIG. 7A is a diagram showing details of a single resource block;

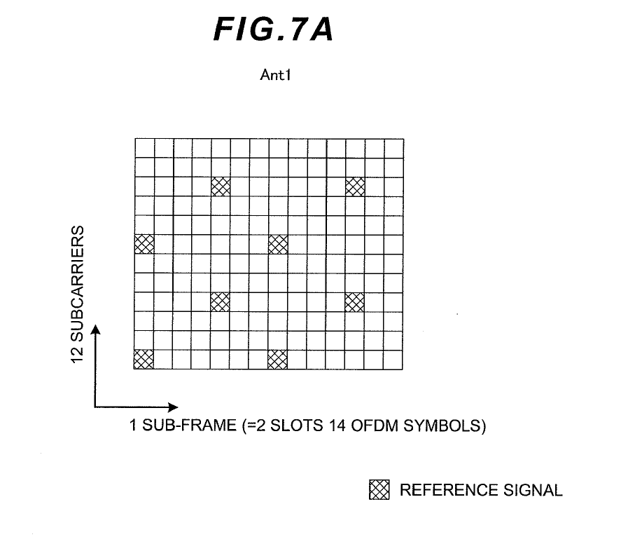

FIG. 7B is another diagram showing details of a single resource block;

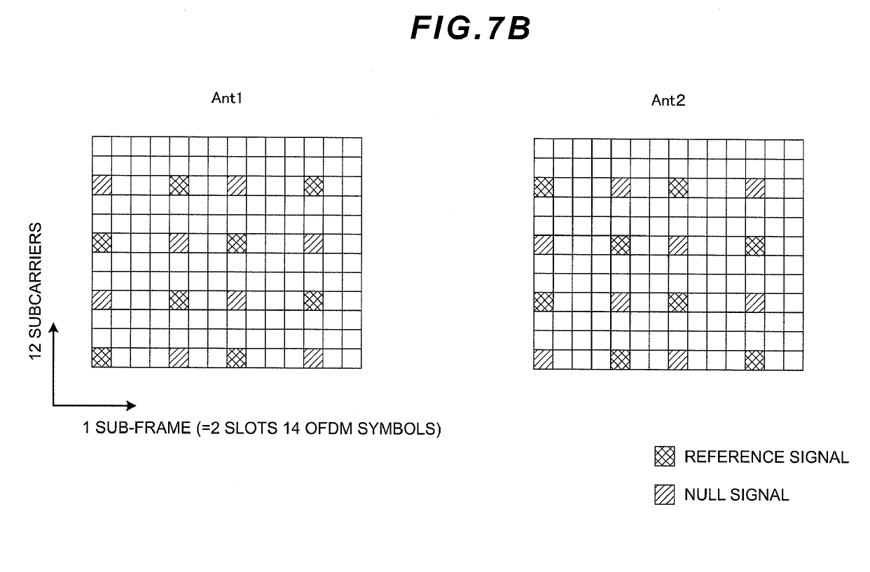

FIG. 7C is still another diagram showing details of a single resource block;

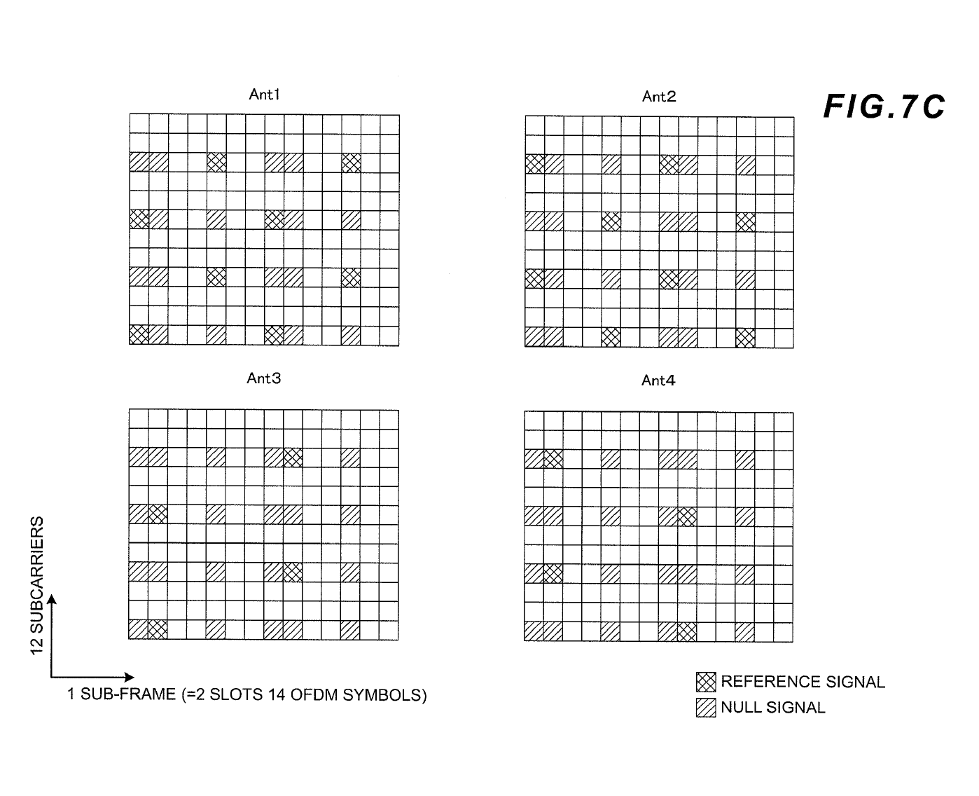

FIG. 8 contains diagrams selectively showing only arrangements of antenna port 1 when the number of antenna ports is “4”;

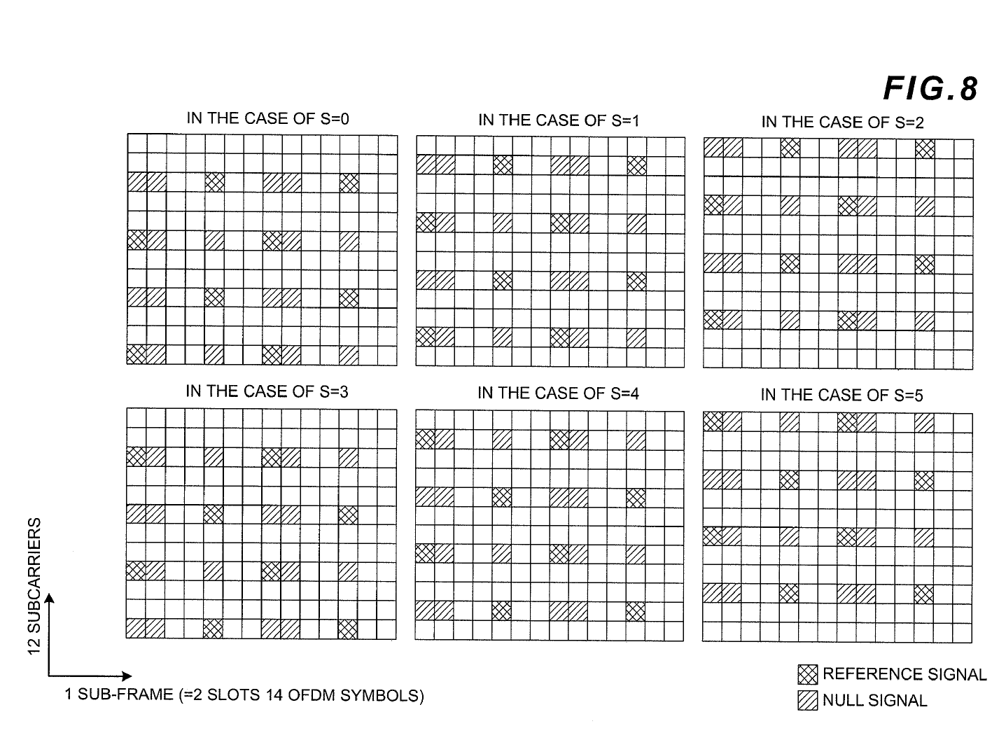

FIG. 9 is a diagram illustrating a frame configuration of A-EUTRA in which component carriers are consecutively arranged;

FIG. 10 is a diagram illustrating a schematic configuration of a base station apparatus of A-EUTRA;

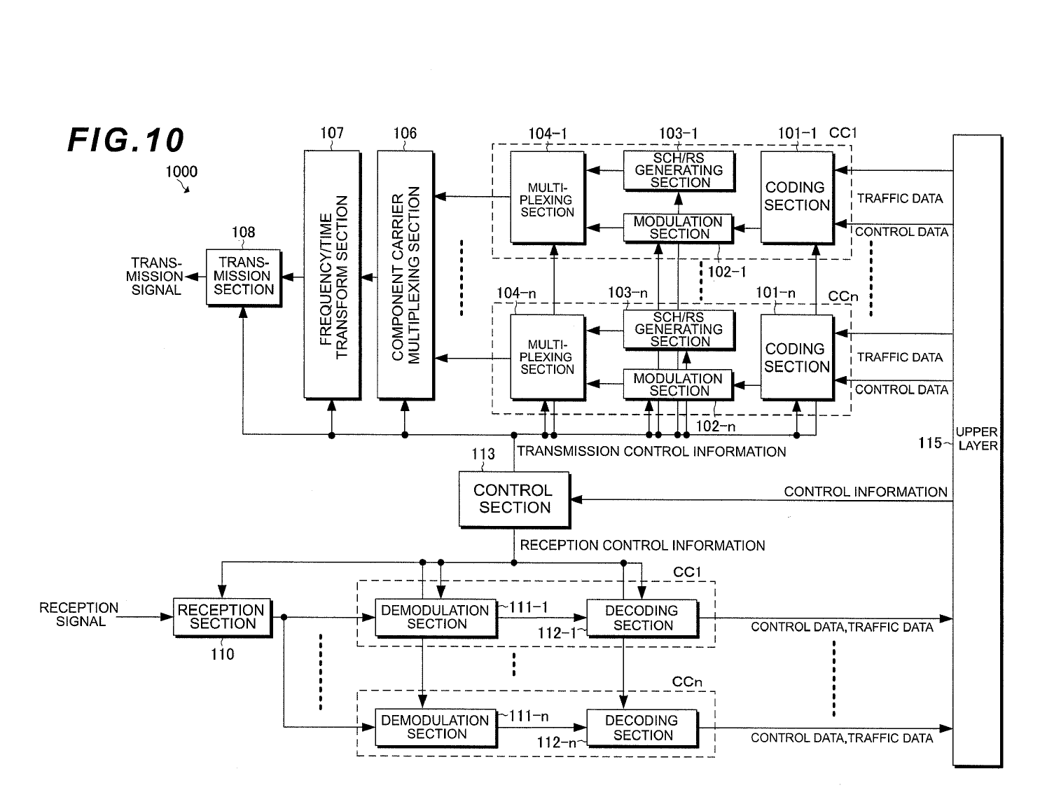

FIG. 11 is a diagram illustrating an arrangement of reference signals used in detecting a phase difference between component carriers; and

FIG. 12 is a diagram showing another example of the reception processing section of the A-EUTRA mobile station apparatus according to this Embodiment.

### BEST MODE FOR CARRYING OUT THE INVENTION

### Embodiment 1

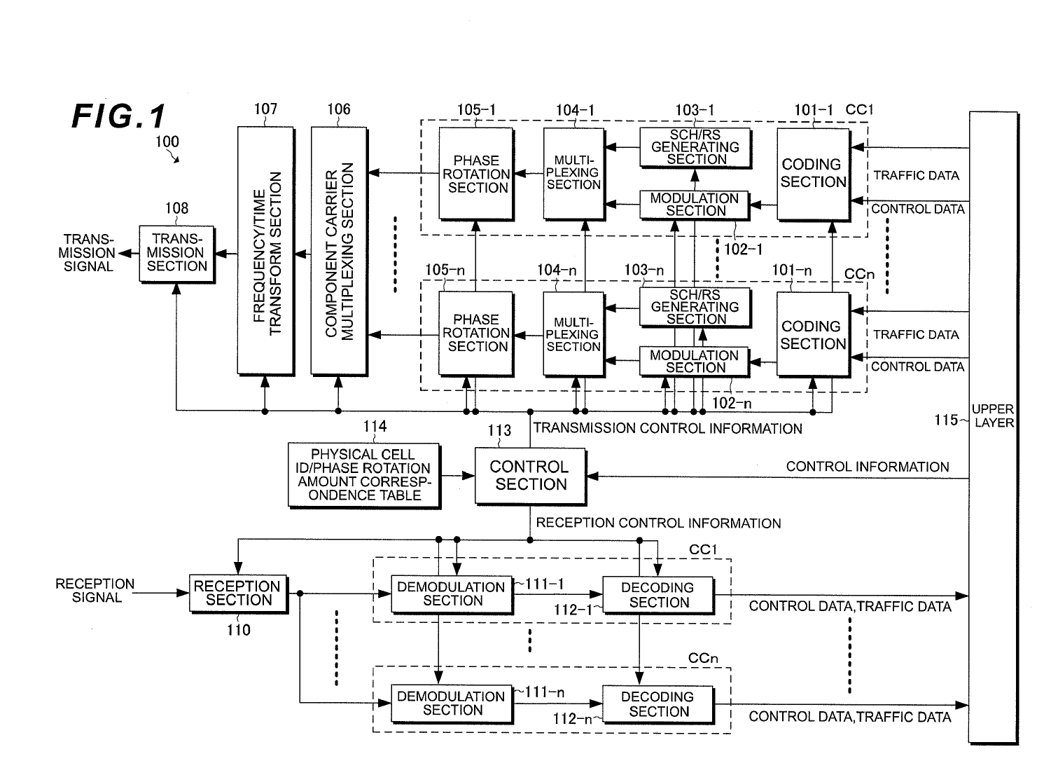

A base station apparatus of A-EUTRA according to Embodiment 1 of the invention will be described below with reference to drawings. FIG. 1 is a block diagram illustrating a schematic configuration of a base station apparatus according to this Embodiment. The base station apparatus 100 in this Embodiment performs coding of transmission data for each component carrier in coding sections 101-1 to 101-n. Further, the apparatus modulates the coded signals in modulation sections 102-1 to 102-n. Furthermore, the apparatus generates synchronization channels and reference signals in SCH/RS generating sections 103-1 to 103-n, based on the physical cell ID (common to all component carriers) and generation timing notified from a control section, described later.

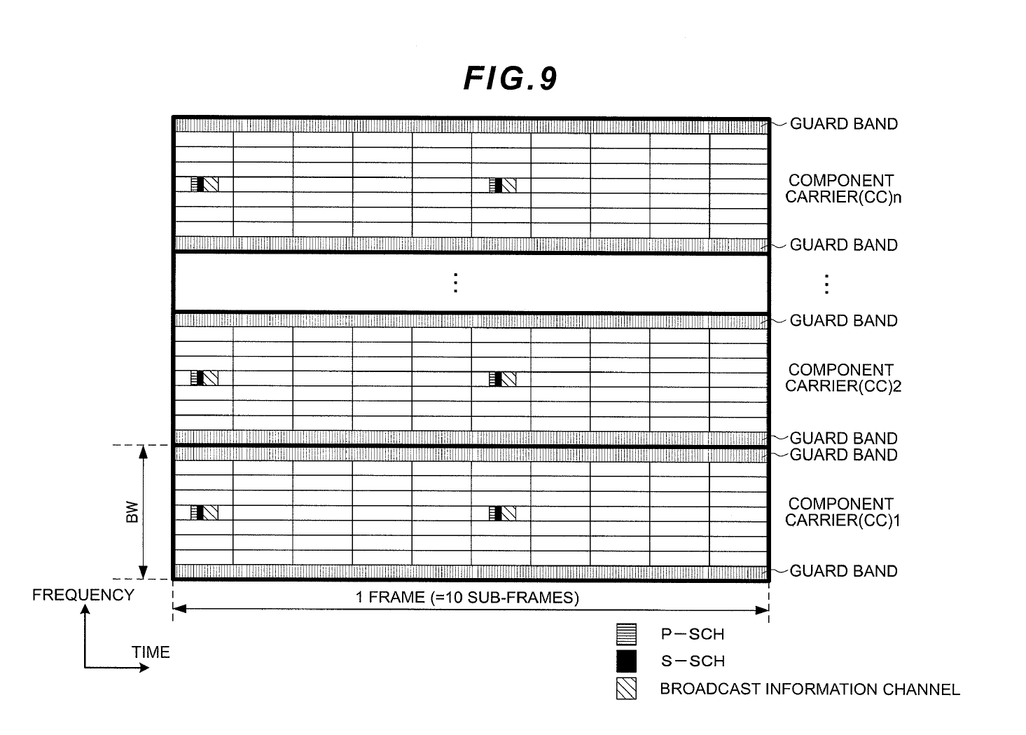

Multiplexing sections 104-1 to 104-n multiplex signals modulated in the modulation sections 102-1 to 102-n, and the synchronization channels and reference signals generated in the SCH/RS generating sections 103-1 to 103-n on an OFDM-symbol basis. Phase rotation sections 105-1 to 105-n rotate the signals multiplexed in the multiplexing sections 104-1 to 104-n by a phase designated by the control section, described later. The component carrier multiplexing section 106 maps the signal corresponding to a single OFDM symbol subjected to phase rotation in the phase rotation sections 105-1 to 105-n for each component carrier to the frequency region as shown in FIG. 9. A frequency/time transform section 107 transforms the signal in the frequency domain multiplexed in the component carrier multiplexing section 106 into a signal in the time domain by IFFT computing. A transmission section 108 converts the digital signal that is transformed into the signal in the time domain into an analog signal, places the signal on a carrier wave of a predetermined frequency to perform power amplification, and transmits the signal. In addition, the above-mentioned coding section 101-1 to transmission section 108 constitute a transmission processing section.

Meanwhile, the base station apparatus 100 converts a signal received from a mobile station apparatus into a digital baseband signal in a reception section 110. Further, the base station apparatus demodulates signals in demodulation sections 111-1 to 111-n for each component carrier, and decodes the demodulated signals in decoding sections 112-1 to 112-n. In addition, the above-mentioned reception section 110 to decoding section 112-n constitute a reception processing section.

The control section 113 controls each component of the above-mentioned transmission processing section and reception processing section. A physical cell ID/phase rotation amount correspondence table 114 associates the physical cell ID with each phase rotation amount of the component carrier to store. An upper layer 115 outputs a transmission signal to the above-mentioned transmission processing section, receives a reception signal from the reception processing section, and outputs control information to the control section 113.

In other words, the base station apparatus 100 adopts the configuration obtained by adding the phase rotation sections 105-1 to 105-n and physical cell ID/phase rotation amount correspondence table 114 to the configuration of the conventional base station apparatus. In the above-mentioned base station apparatus 100, component carrier transmission signals generated up to the multiplexing sections 104-1 to 104-n are given individual phase rotation for each component carrier in the phase rotation sections 105-1 to 105-n, respectively. Each phase rotation amount is designated by the control section 113 based on the physical cell ID/phase rotation amount correspondence table 114. The signal subjected to phase rotation for each component carrier is placed on a subcarrier of an A-EUTRA frame in the component carrier multiplexing section 106 as in the conventional case, transformed into a signal in the time domain in the frequency/time transform section 107, and is transmitted from the transmission section 108.

The following table shows an example of CM values of OFDM symbols including reference signals when phase rotation is not performed in component carriers of n=1 to n=5, and CM values when phase rotation is provided. In addition, as the conditions, the physical cell ID is set at “0” and “18”, a single transmission antenna is used, and the signal power other than the reference signal is set at “0”. Phase rotation A in the table is in the case that the phase rotation amount of each component carrier is (0 degree, 180 degrees, 0 degree, −36 degrees, −18 degrees), phase rotation B is in the case that the phase rotation amount of each component carrier is (0 degree, −72 degrees, −108 degrees, 0 degree, 180 degrees), and Phase rotation C is in the case that the phase rotation amount of each component carrier is (0 degree, −36 degrees, −72 degrees, −108 degrees, −144 degrees).

TABLE 2

| | | n = 1 | n = 2 | n = 3 | n = 4 | n = 5 |
|---|---|---|---|---|---|---|
| Cell ID 0 | No Phase | 4.00 | 6.55 | 8.53 | 10.14 | 11.43 |
| | Rotation | | | | | |
| | Phase | 4.00 | 6.57 | 5.33 | 5.39 | 5.39 |
| | Rotation | | | | | |
| | A | | | | | |
| | Phase | 4.00 | 6.54 | 5.61 | 5.57 | 6.22 |
| | Rotation | | | | | |
| | B | | | | | |
| | Phase | 4.00 | 6.54 | 7.12 | 7.85 | 7.91 |
| | Rotation | | | | | |
| | C | | | | | |
| Cell ID 18 | No Phase | 4.02 | 6.51 | 8.55 | 10.09 | 11.42 |
| | Rotation | | | | | |
| | Phase | 4.02 | 6.49 | 5.38 | 5.33 | 5.32 |
| | Rotation | | | | | |
| | A | | | | | |
| | Phase | 4.02 | 6.51 | 5.52 | 5.50 | 6.15 |
| | Rotation | | | | | |
| | B | | | | | |
| | Phase | 4.02 | 6.51 | 7.03 | 7.79 | 7.74 |
| | Rotation | | | | | |
| | C | | | | | |

From this table, it is understood that it is possible to reduce the CM by providing phase rotation for each component carrier. Further, from comparison between phase rotation A and B, it is understood that the difference arises in the CM value also by setting of phase rotation amount. Therefore, the base station apparatus in this Embodiment beforehand calculates optimal phase rotation amounts for each physical cell ID to refer to as the table.

The following table shows an example of CM calculation results when a random QPSK signal is input as data other than the reference signal. Herein, the case is assumed that the power of the reference signal is boosted by 3 dB than the other signal.

TABLE 3

| | | n = 1 | n = 2 | n = 3 | n = 4 | n = 5 |
|---|---|---|---|---|---|---|
| Cell ID 0 | No Phase | 4.06 | 4.40 | 5.04 | 5.29 | 6.03 |
| | Rotation | | | | | |
| | Phase | 4.06 | 4.45 | 4.28 | 4.09 | 4.12 |
| | Rotation | | | | | |
| | A | | | | | |
| | Phase | 4.06 | 4.54 | 4.32 | 4.10 | 4.47 |
| | Rotation | | | | | |
| | B | | | | | |
| | Phase | 4.06 | 4.50 | 4.56 | 4.64 | 4.74 |
| | Rotation | | | | | |
| | C | | | | | |
| Cell ID 18 | No Phase | 4.30 | 4.77 | 5.19 | 5.47 | 6.16 |
| | Rotation | | | | | |
| | Phase | 4.30 | 4.96 | 4.32 | 4.13 | 4.06 |
| | Rotation | | | | | |
| | A | | | | | |
| | Phase | 4.30 | 4.56 | 4.36 | 4.22 | 4.31 |
| | Rotation | | | | | |
| | B | | | | | |
| | Phase | 4.30 | 4.66 | 4.75 | 4.66 | 4.67 |
| | Rotation | | | | | |
| | C | | | | | |

When the data is inserted, since the data varies with component carriers normally, the CM values are improved as compared with the case of only the reference signal, but from the table, it is understood that the CM values are further improved by phase rotation also when the data is inserted. Further, from two tables shown in Embodiment 1, it is understood that phase rotation (herein, C) poor in characteristics only in the reference signal is poor in characteristics also in the case of including the data. Therefore, in this Embodiment, as phase rotation amounts beforehand set in the physical cell ID/phase rotation amount correspondence table, selected are combinations such that the CM value is the best in the case where only reference signals corresponding to the physical cell ID are arranged. In addition, it is also possible to generate a table by calculating the CM value using the other signal such as the primary synchronization channel, secondary synchronization channel and broadcast information channel that is the same for each component carrier.

Described next is the operation of the mobile station apparatus of EUTRA and the mobile station apparatus of A-EUTRA in a system using the above-mentioned base station apparatus 100. The mobile station apparatus of EUTRA is capable of receiving only a single component carrier in a frame of A-EUTRA. Herein, in a single component carrier in this Embodiment, all subcarriers are provided with uniform phase rotation. Therefore, the mobile station apparatus receiving only the component carrier is capable of compensating for phase rotation provided in the base station apparatus in performing propagation path compensation, without distinguishing from phase rotation in the propagation path. This is the same as in all other component carriers, and the mobile station apparatus of EUTRA that connects with the base station apparatus using each component carrier is capable of performing communications without requiring additional processing according to the invention.

Next, the mobile station apparatus of A-EUTRA concurrently receives signals of a plurality of component carriers, and therefore, when different phase rotation is added in consecutive component carriers, is not capable of performing propagation path compensation across the component carriers without any processing.

As a method of solving the above-mentioned problem, the following methods are conceived.

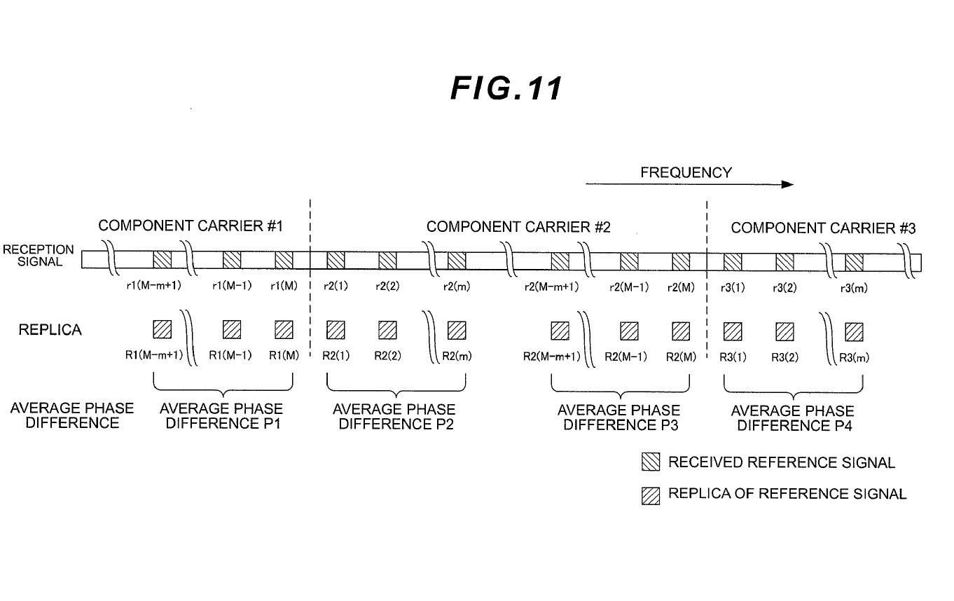

(1) The mobile station apparatus does not perform propagation path compensation across component carriers. In other words, the apparatus performs propagation path compensation for each component carrier. It is assumed that the mobile station apparatus is assigned a plurality of component carriers with discrete frequencies, and therefore, it is possible to perform propagation path compensation individually on consecutive component carriers.
(2) For a mobile station apparatus assigned a plurality of component carriers, a phase rotation amount for each component carrier is beforehand included in an upper control signal (for example, information to notify as system information (SIB)), and the mobile station apparatus restores the added phase rotation by inverse phase rotation based on the information, and performs propagation path compensation across component carriers.
(3) A mobile station apparatus is also provided with the same physical cell ID/phase rotation amount correspondence table as in the base station apparatus, and acquires phase rotation amounts of all the component carriers from the table based on the physical cell ID acquired in one component carrier.
(4) The phase rotation amount of each component is limited to only two kinds, 0 degree and 180 degrees. Then, as shown in FIG. 11, using replicas (reference signals generated in the mobile station apparatus that uniquely correspond to the physical cell ID) of m reference signals from the edge of each component carrier and an actual reception signal, a mobile station apparatus obtains phase rotation amounts at the positions, compares the difference of the phase rotation amount between the adjacent component carrier, and thereby estimates that the difference of the phase rotation amount between the adjacent component carriers is 0 degree or 180 degrees.

As a specific example of above-mentioned method (4), in FIG. 11, it is assumed that r1 is a reference signal included in a single OFDM symbol of component carrier #1 received in the mobile station apparatus, r2 is a reference signal of component carrier #2, r3 is a reference signal of component carrier #3, and that R1, R2 or R3 is a reference signal generated in the mobile station apparatus that uniquely corresponds to the physical cell ID of each component carrier. When the physical cell ID of each component carrier is the same, R1=R2=R3. Further, it is assumed that “M” is the number of reference signals of each component carrier included in a single OFDM symbol.

First, obtained is a phase difference between each of m received reference signals from the edge of the component carrier and a replica, and an average phase difference P of m signals is obtained. For example, using conj ( ) as the function of obtaining a complex conjugate, P1 of FIG. 11 is obtained using the following equation.

P1=(Σ_{k=M-m+1}^{M}r1(k)×conj(R1(k)))/m [Eq. 1]

Similarly, P2, P3 and P4 are obtained.

Next, by comparing phase difference P1 with P2, and P3 with P4, it is possible to obtain the phase difference between component carriers #1 and #2, and the phase difference between component carriers #2 and #3. For example, it is possible to determine that the phase difference is 0 degree when the phase difference between P1 and P2 ranges from −90 degrees to 90 degrees, and that the phase difference is 180 degrees when the phase difference between P1 and P2 is less than −90 degrees or more than 90 degrees.

Herein, the phase rotation amounts are assumed to be 0 degree and 180 degrees, and assuming that 90 degrees are a basis of the phase rotation amount, it is possible to make the determination of the above-mentioned phase difference so that the phase difference is 0 degree when the phase difference ranges from −45 degrees to 45 degrees, the phase difference is 90 degrees when the phase difference ranges from 45 degrees to 135 degrees, the phase difference is 180 degrees when the phase difference ranges from 135 degrees to 225 degrees, and that the phase difference is 270 degree (−90 degrees) when the phase difference ranges from 225 degrees to 315 degrees.

In addition, in the specific example, the phase difference is calculated by averaging on an OFDM-symbol basis (frequency domain), and it is possible to obtain a more accurate phase difference by averaging in the time domain or in both time and frequency domain.

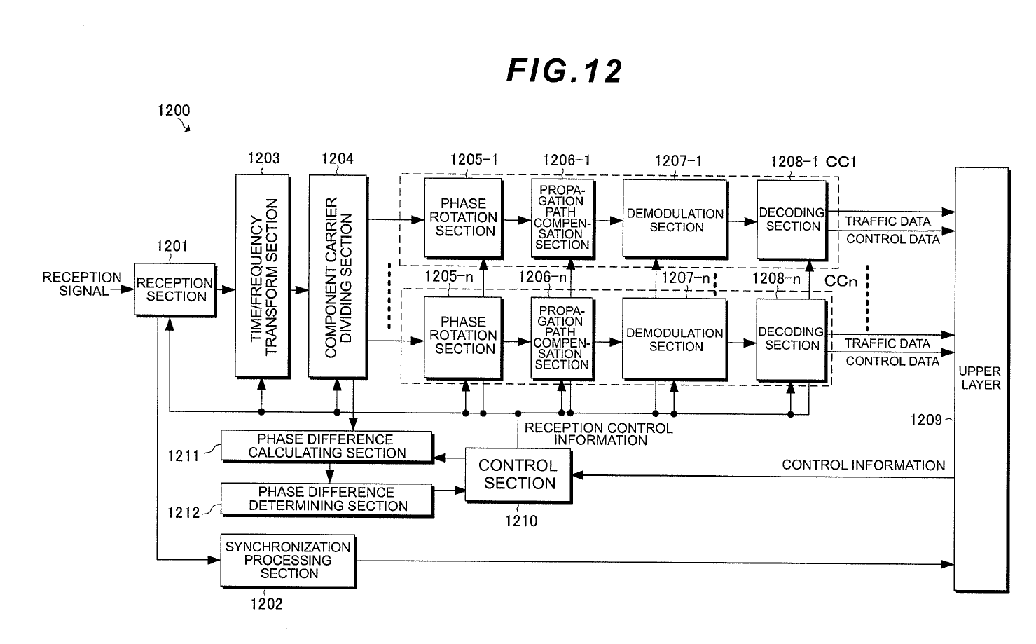

FIG. 12 is a diagram illustrating a schematic configuration of a reception processing section of the A-EUTRA mobile station apparatus that performs the above-mentioned processing. The reception processing section 1200 of the mobile station apparatus converts a reception signal into a baseband signal in a reception section 1201. A synchronization processing section 1202 detects a synchronization channel from the signal received in the reception section 1201, and performs synchronization processing. A time/frequency transform section 1203 transforms the signal in the time domain into a signal in the frequency domain at timing synchronized in the synchronization processing section 1202. A component carrier dividing section 1204 divides the signal in the frequency domain transformed in the time/frequency transform section 1203 into signals of respective component carriers. Further, the section 1203 outputs reference signals obtained from the result of division to a phase difference calculating section 1211.

Phase rotation sections 1205-1 to 1205-n provide the signals of respective component carriers divided in the component carrier dividing section 1204 with phase rotation designated from a control section, described later. Propagation path compensation sections 1206-1 to 1206-n perform propagation path compensation based on reference signals included in the signals undergoing phase rotation in the phase rotation sections 1205-1 to 1205-n. Demodulation sections 1207-1 to 1207-n demodulate the signals undergoing propagation path compensation in the propagation path compensation sections 1206-1 to 1206-n. Decoding sections 1208-1 to 1208-n decode the demodulated signals. An upper layer 1209 receives the decoded signals.

The control section 1210 controls each component. Further, the control section 1210 outputs the physical cell ID and position information of reference signals inside the frame to the phase difference calculating section 1211. The phase difference calculating section 1211 generates replicas of reference signals based on the reference signals input from the component carrier dividing section 1204, and the physical cell ID and position information of reference signals inside the frame input from the control section 1210. Then, the section 1211 calculates a phase difference between the replica and the reference signal to output to the phase difference determining section 1212. The phase difference calculating section 1212 determines a phase rotation amount of each component carrier in transmission from a phase difference between adjacent component carriers to notify the control section 1210.

Described next is the operation of the reception processing section 1200 of the mobile station apparatus configured as described above. First, the reception section 1201 converts a received signal into a digital baseband signal to input to the synchronization processing section 1202. The synchronization processing section 1202 detects the frequency including the synchronization channel to acquire synchronization, and acquires physical cell ID information from the synchronization channel. Further, from the primary broadcast channel, the section 1202 acquires information such as the antenna information and system frame number required for communications. The acquired information is sent to the upper layer 1209. The upper layer 1209 notifies the control section 1210 of information required for subsequent signal demodulation.

The control section 1210 controls each section based on the control information from the upper layer 1209. An output from the reception section 1201 is subjected to FFT transform on an OFDM-symbol basis in the time/frequency transform section 1203 based on the timing information from the control section 1210, and is transformed into a signal in the frequency domain. The transformed signal in the frequency domain is input to the component carrier dividing section 1204. The component carrier dividing section 1204 divides the signal in the frequency domain into information for each component carrier to output to the phase difference calculating section 1211. Based on the physical cell ID notified from the control section 1210, the phase difference calculating section 1211 calculates a phase difference between a replica of the reference signal and the reference signal of each component carrier input from the component carrier dividing section 1204.

The calculated phase difference information of each component carrier is notified to the phase difference determining section 1212. The phase difference determining section 1212 determines a phase difference between adjacent component carriers from the technique as described above using the phase difference information of each component carrier input from the phase difference calculating section 1211, and notifies the control section 1210 of the phase difference. Based on the phase difference information input from the control section 1210, the signal input to each of the phase rotation sections 1205-1 to 1205-n is provided with inverse phase rotation to phase rotation provided in the base station apparatus. The phase-rotated signals are input to the propagation path compensation sections 1206-1 to 1206-n. The propagation path compensation sections 1206-1 to 1206-n perform propagation path compensation based on the reference signals included in the reception signal. The signals subjected to propagation path compensation are demodulated in the demodulation sections 1207-1 to 1207-n, decoded in the decoding sections 1208-1 to 1208-n, and notified to the upper layer 1209.

By using the above-mentioned mobile station apparatus, it is possible to demodulate signals provided with phase rotation. In addition, in the above-mentioned description, propagation path compensation is performed for each component carrier, and naturally, it is also possible to perform propagation path compensation using reference signals of a plurality of component carriers.

In any of the methods, when the same physical cell ID is used in component carriers, by using the base statin apparatus of this Embodiment, it is possible to maintain compatibility with EURTA while suppressing increases in PAPR (CM), and to perform propagation path compensation in A-EUTRA. By this means, the base station apparatus 100 is capable of making power amplification in the transmission section 108 efficient, and when the mobile station apparatus performs the processing (for example, scramble release of the downlink signal, identification of the position and code of the reference signal, etc.) dependent on the physical cell ID, the mobile station apparatus is capable of performing the common processing for each component carrier, and of simplifying the processing.

Further, also at the time of Asymmetric Carrier aggregation, it is possible to provide downlink component carriers sharing uplink with the same physical cell ID. Further, the mobile station apparatus acquires the phase rotation amount provided in each component carrier using the above-mentioned methods (2) to (4) for propagation path compensation, and is thereby capable of using in uses other than propagation path compensation, for example, in measuring the channel quality, and in signal processing in the case called CoMP where a plurality of base station apparatuses and relay station apparatuses coordinate to transmit a signal to a single mobile station apparatus.

### Embodiment 2

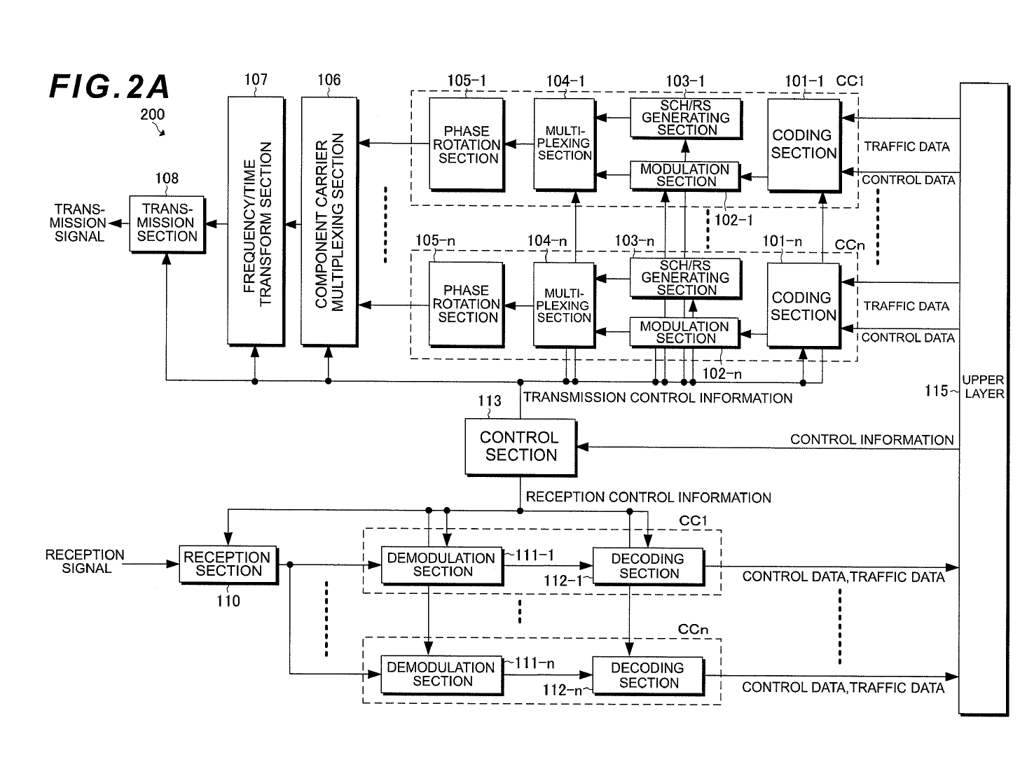

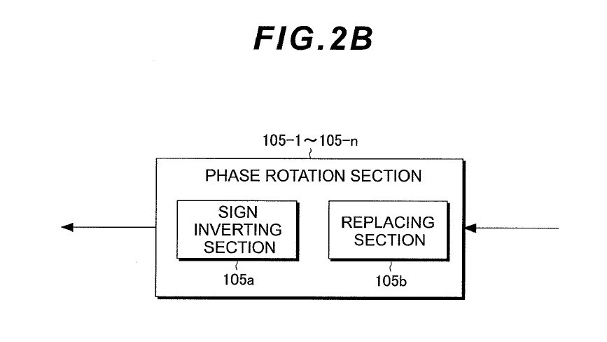

A base station apparatus of A-EUTRA according to Embodiment 2 of the invention will be described below with reference to drawings. FIG. 2A is a block diagram illustrating a schematic configuration of a base station apparatus according to Embodiment 2. The base station apparatus 200 differs from that in Embodiment 1, and is configured by adding only phase rotation sections 105-1 to 105-n to the processing for each component carrier of the conventional base station apparatus. In other words, the base station apparatus 200 in this Embodiment performs coding of transmission data for each component carrier in coding sections 101-1 to 101-n. Further, the apparatus modulates the coded signals in modulation sections 102-1 to 102-n. Furthermore, the apparatus generates synchronization channels and reference signals in SCH/RS generating sections 103-1 to 103-n, based on the physical cell ID (common to all component carriers) and generation timing notified from the control section, described later. Multiplexing sections 104-1 to 104-n multiplex signals modulated in the modulation sections 102-1 to 102-n, and the synchronization channels and reference signals generated in the SCH/RS generating sections 103-1 to 103-n on an OFDM-symbol basis.

Phase rotation sections 105-1 to 105-n rotate the signals multiplexed in the multiplexing sections 104-1 to 104-n by a phase designated by the control section, described later. FIG. 2B is a block diagram illustrating a schematic configuration of the phase rotation section. A sign inverting section 105a performs sign inversion on the signals input from the multiplexing sections 104-1 to 104-n. A replacing section 105b replaces a real part and an imaginary part of the input signal with each other.

The component carrier multiplexing section 106 maps the signal corresponding to a single OFDM symbol subjected to phase rotation in the phase rotation sections 105-1 to 105-n for each component carrier to the frequency region as shown in FIG. 9. The frequency/time transform section 107 transforms the signal in the frequency domain multiplexed in the component carrier multiplexing section 106 into a signal in the time domain by IFFT computing. The transmission section 108 converts the digital signal that is transformed into the signal in the time domain into an analog signal, places the signal on a carrier wave of a predetermined frequency to perform power amplification, and transmits the signal. In addition, the above-mentioned coding section 101-1 to transmission section 108 constitute the transmission processing section.

Meanwhile, the base station apparatus 200 converts a signal received from a mobile station apparatus into a digital baseband signal in the reception section 110. Further, the base station apparatus demodulates signals in demodulation sections 111-1 to 111-n for each component carrier, and decodes the demodulated signals in decoding sections 112-1 to 112-n. In addition, the above-mentioned reception section 110 to decoding section 112-n constitute the reception processing section. The control section 113 controls each component of the above-mentioned transmission processing section and reception processing section. The upper layer 115 outputs a transmission signal to the above-mentioned transmission processing section, receives a reception signal from the reception processing section, and outputs control information to the control section 113.

In the above-mentioned base station apparatus, the component carrier transmission signal generated in each of the multiplexing sections 104-1 to 104-n is provided with individual phase rotation for each component carrier in respective one of the phase rotation sections 105-1 to 105-n. Each phase rotation amount is designated from among 0 degree, 90 degrees, 180 degrees, and 270 degrees. In other words, the phase rotation sections 105-1 to 105-n are capable of being configured by replacing the real part and the imaginary part of an input signal represented by a complex number, and inverting the sign. More specifically, in the case of performing 0-degree phase rotation, the input signal is output without any processing. Meanwhile, in the case of performing 90-degree phase rotation, the sign of the imaginary part of the input signal is inverted, the imaginary part is replaced with the real part, and the input signal is output. Further, in the case of performing 180-degree phase rotation, the sign of the real part of the input signal is inverted, and the input signal is output. In the case of performing 270-degree phase rotation, the sign of the real part of the input signal is inverted, the real part is replaced with the imaginary part, and the input signal is output.

The signal subjected to phase rotation for each component carrier is placed on a subcarrier of an A-EUTRA frame in the component carrier multiplexing section 106 as in Embodiment 1, transformed into a signal in the time domain in the frequency/time transform section 107, and is transmitted from the transmission section 108.

The following table shows an example of CM values of OFDM symbols including reference signals when phase rotation is not performed in component carriers of n=1 to n=5, and CM values when phase rotation is provided. In addition, as the conditions, the physical cell ID is set at “0” and “18”, a single transmission antenna is used, and the signal power other than the reference signal is set at “0”. Phase rotation D in the table is in the case that the phase rotation amount of each component carrier is (0 degree, 90 degrees, 90 degrees, 0 degree, 180 degrees), and phase rotation A is the same as in Embodiment 1.

TABLE 4

| | | n = 1 | n = 2 | n = 3 | n = 4 | n = 5 |
|---|---|---|---|---|---|---|
| Cell ID 0 | No Phase | 4.00 | 6.55 | 8.53 | 10.14 | 11.43 |
| | Rotation | | | | | |
| | Phase | 4.00 | 6.57 | 5.33 | 5.39 | 5.39 |
| | Rotation | | | | | |
| | A | | | | | |
| | Phase | 4.00 | 6.58 | 5.33 | 5.56 | 5.99 |
| | Rotation | | | | | |
| | D | | | | | |
| Cell ID 18 | No Phase | 4.02 | 6.51 | 8.55 | 10.09 | 11.42 |
| | Rotation | | | | | |
| | Phase | 4.02 | 6.49 | 5.38 | 5.33 | 5.32 |
| | Rotation | | | | | |
| | A | | | | | |
| | Phase | 4.02 | 6.48 | 5.38 | 5.51 | 5.91 |
| | Rotation | | | | | |
| | D | | | | | |

From this table, it is understood that it is possible to also obtain the effect of reducing the CM by providing phase rotation limited to a 90-degree basis. Therefore, the base station apparatus in this Embodiment is capable of maintaining the same PAPR (CM) characteristics as in Embodiment 1, while simplifying the circuit configuration of the base station apparatus.

In above-mentioned Embodiments 1 and 2, the example is described where in calculating a phase rotation amount, combinations for keeping the CM value low are calculated irrespective of the number of component carriers. In other words, in the same physical cell ID, the phase rotation amount corresponding to the component carrier number does not change when the number of aggregated component carriers is “2”, “3”, “4” or “5”. The advantage of this scheme is to enable reductions in the CM value of a signal transmitted from an unsophisticated base station apparatus or relay station apparatus, for example, in the case of installing the unsophisticated base station apparatus or relay station apparatus inside a cell as extension and transmitting the same signal as only part (for example, three component carriers) of component carriers of the basic base station apparatus, for the purpose of eliminating coverage holes (areas such as a valley between buildings at which the radio signal does not arrive) of the basic base station apparatus in the cell in which the number of aggregated component carriers is four.

However, when it is possible to use a value different from the basis base station apparatus as the phase rotation amount in transmitting from the unsophisticated base station apparatus or relay station apparatus, an optimal phase rotation amount may be obtained corresponding to the number of aggregated component carriers.

### Embodiment 3

A base station apparatus of A-EUTRA according to Embodiment 3 of the invention will be described below with reference to drawings. In EUTRA or A-EUTRA, the mechanism called a Self Organized Network (SON) is proposed in which optimization of the communication system is automatically performed, and it is considered setting and varying the physical cell ID corresponding to the circumstances of adjacent cells. In performing optimization for each component carrier by SON, there is a case that the same physical cell ID is used among only part of component carriers. Therefore, this Embodiment describes the base statin apparatus in the case where the physical cell ID of each component carrier is automatically determined.

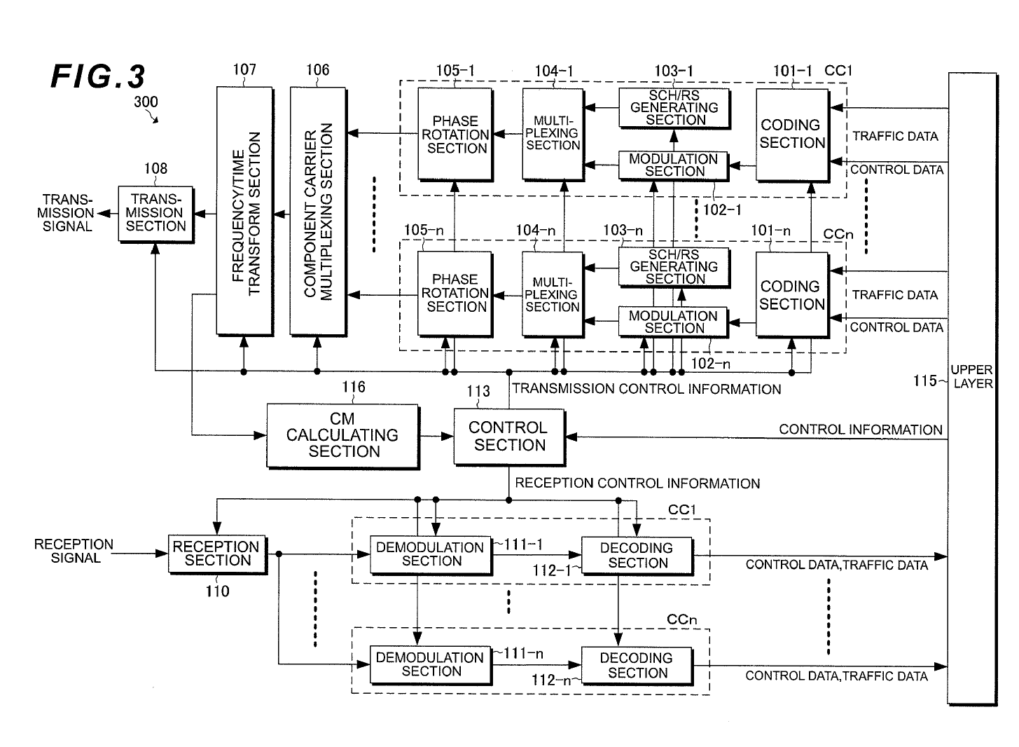

FIG. 3 is a block diagram illustrating a schematic configuration of a base station apparatus according to Embodiment 3. The base station apparatus 300 adopts a configuration obtained by adding a CM calculating section 116 to the configuration of the conventional base station apparatus. The base station apparatus performs coding of transmission data for each component carrier in coding sections 101-1 to 101-n. Further, the apparatus modulates the coded signals in modulation sections 102-1 to 102-n. Furthermore, the apparatus generates synchronization channels and reference signals in SCH/RS generating sections 103-1 to 103-n, based on the physical cell ID (common to all component carriers) and generation timing notified from the control section, described later.

Multiplexing sections 104-1 to 104-n multiplex signals modulated in the modulation sections 102-1 to 102-n, and the synchronization channels and reference signals generated in the SCH/RS generating sections 103-1 to 103-n on an OFDM-symbol basis. Phase rotation sections 105-1 to 105-n rotate the signals multiplexed in the multiplexing sections 104-1 to 104-n by a phase designated by the control section, described later. The component carrier multiplexing section 106 maps the signal corresponding to a single OFDM symbol subjected to phase rotation in the phase rotation sections 105-1 to 105-n for each component carrier to the frequency region as shown in FIG. 9. The frequency/time transform section 107 transforms the signal in the frequency domain multiplexed in the component carrier multiplexing section 106 into a signal in the time domain by IFFT computing.

The CM calculating section 116 calculates a CM of the signal that is transformed in the frequency/time transform section 107. The transmission section 108 converts the digital signal that is transformed into the signal in the time domain into an analog signal, places the signal on a carrier wave of a predetermined frequency to perform power amplification, and transmits the signal. In addition, the above-mentioned coding section 101-1 to transmission section 108 constitute the transmission processing section.

Meanwhile, the base station apparatus 300 converts a signal received from a mobile station apparatus into a digital baseband signal in the reception section 110 as the reception processing section. Further, the base station apparatus demodulates signals in demodulation sections 111-1 to 111-n for each component carrier, and decodes the demodulated signals in decoding sections 112-1 to 112-n. In addition, the above-mentioned reception section 110 to decoding section 112-n constitute the reception processing section.

The control section 113 controls each component of the above-mentioned transmission processing section and reception processing section. The upper layer 115 outputs a transmission signal to the above-mentioned transmission processing section, receives a reception signal from the reception processing section, and outputs control information to the control section 113.

When the physical cell ID is determined or changed, the base station apparatus 300 performs the following operation. First, the control section 113 notifies the SCH/RS generating sections 103-1 to 103-n of the physical cell ID for each component carrier. The SCH/RS generating sections 103-1 to 103-n generate reference signals to output to the multiplexing sections 104-1 to 104-n. The multiplexing sections 104-1 to 104-n output null signals except the reference signals to the phase rotation sections 105-1 to 105-n. The control section 113 notifies different phase rotation amounts to phase rotation sections 105-1 to 105-n for component carriers of the same physical cell ID, and designates 0 degree as the phase rotation amount to phase rotation sections 105-1 to 105-n of component carriers except the component carriers of the same ID.

Each of the phase rotation sections 105-1 to 105-n adds the phase rotation amount designated by the control section 113 to the input signal from respective one of the multiplexing sections 104-1 to 104-n. The phase-rotated signals of respective component carriers are multiplexed in the component carrier multiplexing section 106, and transformed into a signal in the time domain in the frequency/time transform section 107.

An output signal of the frequency/time transform section 107 is input to the CM calculating section 116, and the CM value is calculated. The calculated CM value is input to the control section 113, and the processing is repeated by changing the phase rotation amount of component carriers of the same physical cell ID until the CM value meets a condition. Examples of the condition for the CM value to meet are as described below.

(1) The CM value falls below a predetermined threshold.
(2) The CM value is the lowest among combinations of the finite number of phase rotation amounts.

Further, when all of the combinations of above-mentioned condition (2) exceed the predetermined threshold, it is conceivable to change the physical cell ID.

When the phase rotation amount is set by the aforementioned processing, as in the base station apparatus of Embodiment 1, the transmission section 108 performs transmission using the set phase rotation amount.

As described above, according to Embodiment 3, even when the physical cell ID of the component carrier is set or changed individually, it is possible to make power amplification in the transmission section 108 efficient.

### Embodiment 4

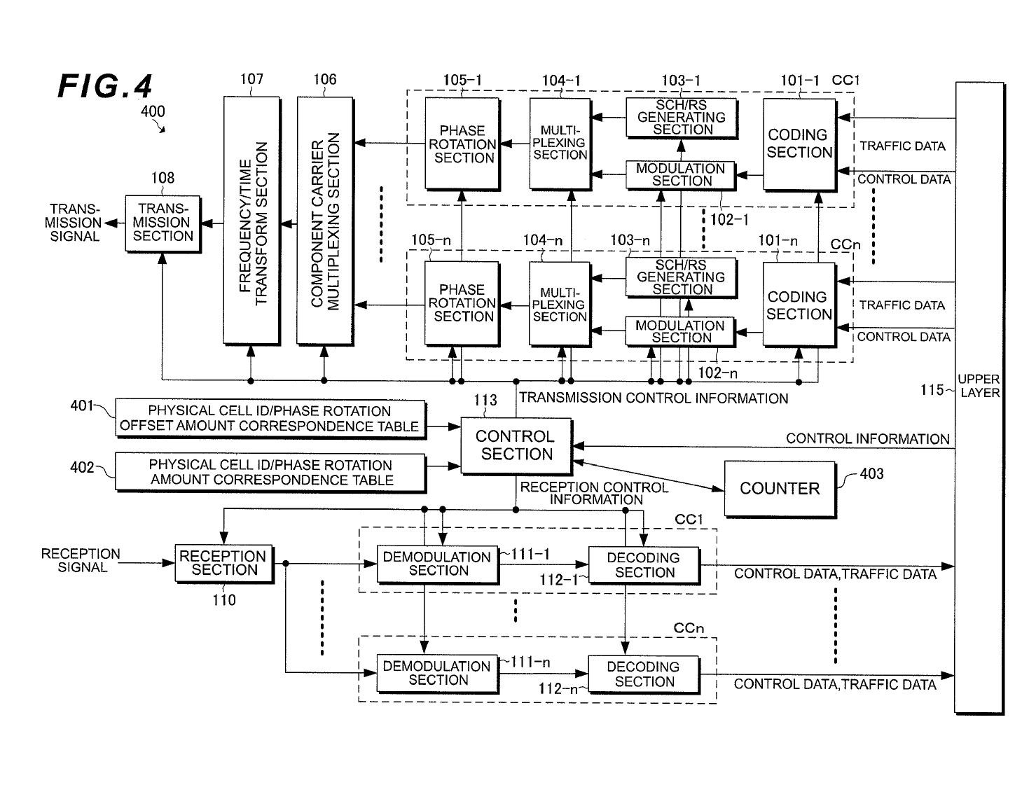

A base station apparatus of A-EUTRA according to Embodiment 4 of the invention will be described below with reference to drawings. In this Embodiment, the phase rotation amount in the time domain is controlled corresponding to the physical cell ID. By controlling the phase rotation amount in the time domain corresponding to the physical cell ID, signals of adjacent cells (having different physical cell IDs) rotate in phase independently with time, and it is possible to randomize interference. FIG. 4 is a block diagram illustrating a schematic configuration of a base station apparatus according to this Embodiment. The base station apparatus 400 adopts a configuration obtained by adding a physical cell ID/phase rotation offset amount correspondence table 401, physical cell ID/phase rotation amount correspondence table 402 and counter 403 to the configuration of the conventional base station apparatus.

The base station apparatus performs coding of transmission data for each component carrier in coding sections 101-1 to 101-n. Further, the apparatus modulates the coded signals in modulation sections 102-1 to 102-n. Furthermore, the apparatus generates synchronization channels and reference signals in SCH/RS generating sections 103-1 to 103-n, based on the physical cell ID (common to all component carriers) and generation timing notified from the control section, described later.

Multiplexing sections 104-1 to 104-n multiplex signals modulated in the modulation sections 102-1 to 102-n, and the synchronization channels and reference signals generated in the SCH/RS generating sections 103-1 to 103-n on an OFDM-symbol basis. Phase rotation sections 105-1 to 105-n rotate the signals multiplexed in the multiplexing sections 104-1 to 104-n by a phase designated by the control section, described later. The component carrier multiplexing section 106 maps the signal corresponding to a single OFDM symbol subjected to phase rotation in the phase rotation sections 105-1 to 105-n for each component carrier to the frequency region as shown in FIG. 9. The frequency/time transform section 107 transforms the signal in the frequency domain multiplexed in the component carrier multiplexing section 106 into a signal in the time domain by IFFT computing. The transmission section 108 converts the digital signal that is transformed into the signal in the time domain into an analog signal, places the signal on a carrier wave of a predetermined frequency to perform power amplification, and transmits the signal. In addition, the above-mentioned coding section 101-1 to transmission section 108 constitute the transmission processing section.

Meanwhile, the base station apparatus 400 converts a signal received from a mobile station apparatus into a digital baseband signal in the reception section 110. Further, the base station apparatus demodulates signals in demodulation sections 111-1 to 111-n for each component carrier, and decodes the demodulated signals in decoding sections 112-1 to 112-n. In addition, the above-mentioned reception section 110 to decoding section 112-n constitute the reception processing section.

The control section 113 controls each component of the above-mentioned transmission processing section and reception processing section. The upper layer 115 outputs a transmission signal to the above-mentioned transmission processing section, receives a reception signal from the reception processing section, and outputs control information to the control section 113.

The physical cell ID/phase rotation offset amount correspondence table 401 associates the physical cell ID with the phase rotation offset amount in the time domain to store. Meanwhile, the physical cell ID/phase rotation amount correspondence table 402 associates the physical cell ID with each phase rotation amount of the component carrier to store. Further, the counter 403 performs count by control of the control section 113.

In the above-mentioned base station apparatus 400, component carrier transmission signals generated up to multiplexing sections 104-1 to 104-n are provided with individual phase rotation for each component carrier designated from the control section 113 in the phase rotation sections 105-1 to 105-n, respectively. Each phase rotation amount is designed by the control section 113 based on the physical cell ID/phase rotation amount correspondence table 402, physical cell ID/phase rotation offset amount correspondence table 401, and a value of the counter 403.

More specifically, assuming that d is a physical cell ID, Rc (d,f) is a phase rotation amount of a component carrier f stored in the physical cell ID/phase rotation amount correspondence table, and that ΔR (d, t) is a phase rotation offset amount in a counter value t stored in the physical cell ID/phase rotation offset amount correspondence table, the phase rotation amount R (d, f, t) of each component carrier in the counter value t is given by the following equation:

$$R ( d , f , t ) = Rc ( d , f ) + {\sum }_{T = 0}^{t} Δ R ( d , T ) \qquad [ Eq . 2 ]$$

where the following equation is the condition:

$${\sum }_{T = 0}^{S - 1} Δ R ( d , T ) = 0 \qquad [ Eq . 3 ]$$

S in the above-mentioned equation is a period, and when the value of the counter is counted up from “0” to S−1, the value is next “0”. According to the above-mentioned condition, the phase rotation amount R is given a different offset amount for each physical cell ID whenever count-up, and returns again to the phase rotation amount prior to addition of the offset after the period S.

For example, in the case where count-up of the counter is made for each sub-frame, and the period S is set at “10”, the phase rotation amount for each sub-frame varies at one-frame (ten-sub-frame) intervals. Meanwhile, count-up of the counter is made for each OFDM symbol, the period S is set at “14”, and it is thereby possible to vary the phase rotation amount at intervals of one sub-frame. Further, when count-up is made for each frame, the phase rotation amount for each frame varies at intervals of a plurality of frames. In this case, it is possible to determine a frame that is the reference to start count-up based on the system frame information (SFN) included in the primary broadcast channel (P-BCH).

The signal subjected to phase rotation for each component carrier is placed on a subcarrier of an A-EUTRA frame in the component carrier multiplexing section as in the conventional case, transformed into a signal in the time domain in the frequency/time transform section, and is transmitted from the transmission section.

Described next is the operation of the mobile station apparatus of EUTRA and the mobile station apparatus of A-EUTRA in a system using the above-mentioned base station apparatus. The mobile station apparatus of EUTRA is capable of receiving only a single component carrier in a frame of A-EUTRA. Herein, in a single component carrier in this Embodiment, all subcarriers are provided with uniform phase rotation within a period of count-up of the counter.

Therefore, in the mobile station apparatus that receives only the component carrier, the mobile station apparatus that performs propagation path compensation for each period of count-up is capable of compensating for phase rotation provided in the base station apparatus in performing propagation path compensation, and the mobile station apparatus of EUTRA that connects with the base station apparatus using each component carrier is capable of performing communications without requiring additional processing according to the invention. Further, also in the case of performing propagation path compensation while exceeding the period of count-up, by controlling the value of ΔR to within conceivable time variations in the propagation path, it is possible to reduce the error in propagation path compensation.

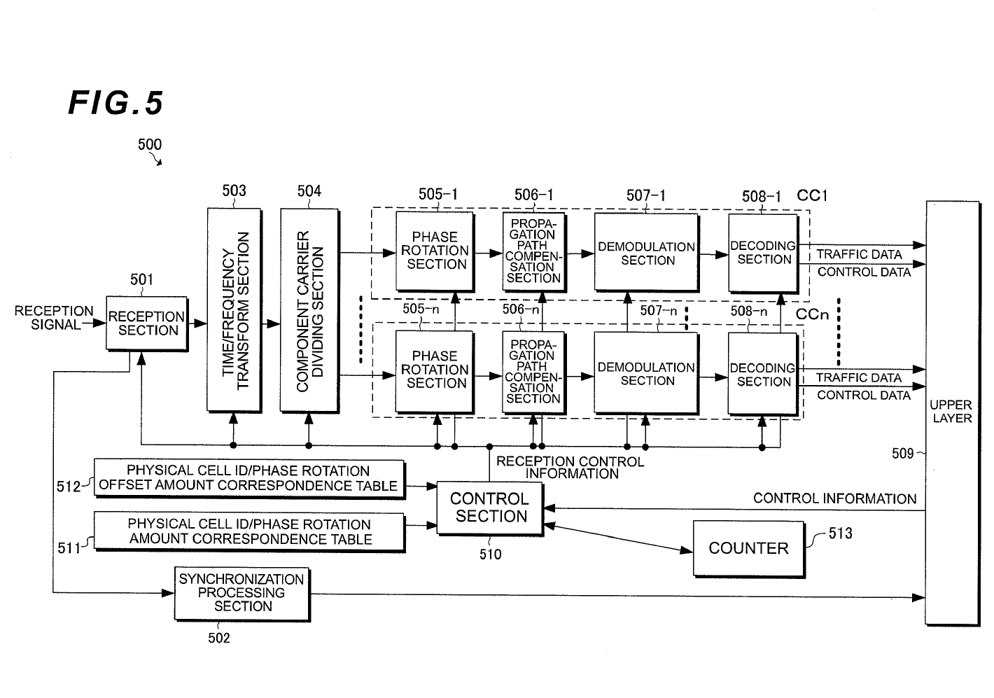

The mobile station apparatus of A-EUTRA will be described below. FIG. 5 is a diagram illustrating a schematic configuration of a reception processing section of an A-EUTRA mobile station apparatus according to this Embodiment. The reception processing section 500 of the mobile station apparatus converts a reception signal into a baseband signal in a reception section 501. A synchronization processing section 502 detects a synchronization channel from the signal received in the reception section 501, and performs synchronization processing. A time/frequency transform section 503 transforms the signal in the time domain into a signal in the frequency domain at timing synchronized in the synchronization processing section 502. A component carrier dividing section 504 divides the signal in the frequency domain transformed in the time/frequency transform section 503 into signals of respective component carriers.

Phase rotation sections 505-1 to 505-n provide the signals of respective component carriers divided in the component carrier dividing section 504 with phase rotation designated from a control section, described later. Propagation path compensation sections 506-1 to 506-n perform propagation path compensation based on reference signals included in the signals undergoing phase rotation in the phase rotation sections 505-1 to 505-n. Demodulation sections 507-1 to 507-n demodulate the signals undergoing propagation path compensation in the propagation path compensation sections 506-1 to 506-n. Decoding sections 508-1 to 508-n decode the demodulated signals. An upper layer 509 receives the decoded signals.

The control section 510 controls each component. A physical cell ID/phase rotation amount correspondence table 511 associates the physical cell ID with each phase rotation amount of the component carrier to store. A physical cell ID/phase rotation offset amount correspondence table 512 associates the physical cell ID with the phase rotation offset amount in the time domain to store. A counter 513 performs count by control of the control section 510.

Described next is the operation of the reception processing section 500 of the mobile station apparatus configured as described above. First, the reception section 501 converts a received signal into a digital baseband signal to input to the synchronization processing section 502. The synchronization processing section 502 detects the frequency including the synchronization channel to acquire synchronization, and acquires physical cell ID information from the synchronization channel. Further, from the primary broadcast channel, the section 502 acquires information such as the antenna information and system frame number required for communications. The acquired information is sent to the upper layer 509, and the upper layer 509 notifies the control section 510 of information required for subsequent signal demodulation.

The control section 510 controls each section based on the control information from the upper layer 509. An output from the reception section 501 is subjected to FFT transform on an OFDM symbol basis in the time/frequency transform section 503 based on the timing information from the control section 510, and is transformed into a signal in the frequency domain. The transformed signal in the frequency domain is divided into information for each component carrier in the component carrier dividing section 504, and is output to respective phase rotation sections 505-1 to 505-n.

The control section 510 counts up the counter 513 based on synchronization timing and system frame information notified from the upper layer 509, and provides each component carrier with inverse phase rotation to phase rotation provided in the base station apparatus, based on the physical cell ID/phase rotation amount correspondence table 511, physical cell ID/phase rotation offset amount correspondence table 512, and the value of the counter 513.

The phase-rotated signals are input to the propagation path compensation sections 506-1 to 506-n, and undergo propagation path compensation based on the reference signal included in the reception signal. The signals subjected to propagation path compensation are demodulated in the demodulation sections 507-1 to 507-n, decoded in the decoding sections 508-1 to 508-n, and notified to the upper layer 509.

According to the aforementioned processing, when the A-EUTRA mobile station apparatus performs propagation path compensation exceeding the period of count-up, the mobile station apparatus removes a phase rotation offset added in the base station apparatus before the propagation path compensation section, and is thereby capable of performing propagation path compensation with high accuracy.

According to Embodiment 4, in the case of using the same physical cell ID among component carriers, by using the base station apparatus of this Embodiment, the EUTRA mobile station apparatus and A-EUTRA mobile station apparatus are capable of performing propagation path compensation with increases in PAPR (CM) suppressed while maintaining compatibility with EUTRA. Further, by designating different phase rotation offset amounts for each physical cell ID, phases of transmission signals between base stations vary independently at count-up intervals, and it is possible to randomize interference imposed on mobile station apparatuses that receive signals in the cell boundary.

In addition, in this Embodiment, the tables are provided to generate the phase rotation amount, but the invention is not limited thereto, and the offset amount may be set using a sequence that is uniquely calculated from the physical cell ID. Further, the offset amount may be generated with ease by setting the period S at an even number, generating code sequences comprised of S/2 “1”s and S/2 “0”s corresponding to the number of physical cell IDs, and from the beginning of the code sequence, sequentially setting the offset at x degrees in “0”, while setting the offset at −x degrees in “1”, or the like.

### Embodiment 5

A base station apparatus of A-EUTRA according to Embodiment 5 of the invention will be described below. In Embodiment 3, when physical cell IDs of part of component carriers are different, the CM is calculated again, and the phase rotation amount is obtained. In this Embodiment, it is beforehand defined to perform any processing described below without calculating the CM.

(1) Using the physical cell ID/phase rotation amount correspondence table of Embodiment 1 that holds optimal phase rotation amounts for each component carrier in the case that all component carriers are provided with the same physical cell ID, applied is the phase rotation amount associated with the component carrier number in the physical cell ID of each component carrier. For example, in the case of using the physical cell ID/phase rotation amount correspondence table in the following table, the phase rotation amount of each component carrier is (Ro1, Ro2, Ro3, Ro4, Ro5) when the physical cell ID of all component carriers is “0”, and when the physical cell ID of each component carrier is (0, 1, 2, 0, 0), the phase rotation amount is (Ro1, Ro7, Ro13, Ro4, Ro5).

TABLE 5

| | |
|---|---|
| | Phase rotation amount for each |
| Physical | component carrier number |

| Cell ID | n = 1 | n = 2 | n = 3 | n = 4 | n = 5 |
|---|---|---|---|---|---|
| 0 | Ro1 | Ro2 | Ro3 | Ro4 | Ro5 |
| 1 | Ro6 | Ro7 | Ro8 | Ro9 | Ro10 |
| 2 | Ro11 | Ro12 | Ro13 | Ro14 | Ro15 |
| . . . | . . . | . . . | . . . | . . . | . . . |

(2) When the physical cell ID of any of component carriers is a different ID from the others, the phase rotation amounts of all component carriers are set at “0”.

By defining adopting any processing as described above, the need is eliminated for notifying the mobile station apparatus of the phase rotation amount, while keeping the CM value low.

### Embodiment 6

A base station apparatus of A-EUTRA according to Embodiment 6 of the invention will be described below. In Embodiment 2 described previously, the phase rotation amount is set on a 90-degree basis, and the circuit scale is thereby simplified while maintaining PAPR (CM) characteristics. This Embodiment describes the technique for varying the basis for phase rotation amount corresponding to the number of aggregated component carriers, and thereby effectively obtaining PAPR characteristics while suppressing increases in the circuit scale.

The following table is to derive optimal CM values from among combinations of all phase rotation on each phase rotation basis, in the case that the number of aggregated component carriers is “3”, “4” and “5”, the physical cell ID is “31”, and the basis for phase rotation amount in each component carrier is 45 degrees, 90 degrees, and 180 degrees.

TABLE 6

| The number of | | | |
|---|---|---|---|
| aggregated | CM value associated with the basis | | |
| component | for phase rotation amount | | |
| carriers | 45 degrees | 90 degrees | 180 degrees |
| 3 | 6.22 | 7.37 | 7.37 |
| 4 | 6.80 | 6.98 | 6.98 |
| 5 | 6.36 | 6.51 | 6.55 |

From this table, it is understood that a difference of more than 1 dB arises between a 45-degree basis and a 90-degree basis when the number of component carriers is “3”, and that any significant difference does not arise due to the basis for phase rotation when the number of component carriers is “4” and “5”. From the fact, when the basis for phase rotation amount is set at D3, D4 or D5 in the case where the number of aggregated component carriers is “3”, “4” or “5”, respectively, the basis for phase rotation amount is determined so as to meet the condition of D3≦D4≦D5, and it is thereby possible to simplify the circuit scale corresponding to the number of component carriers aggregated in each base station apparatus.

Further, the mobile station apparatus that receives signals transmitted from the above-mentioned base station apparatus varies the rotation amount basis in the phase difference determining section of the mobile station apparatus of FIG. 12 described in Embodiment 1, corresponding to the number of component carriers of the connected base station apparatus, and is thereby capable of reducing the determination error.

The above-mentioned Embodiments 1 to 6 describe the base station apparatuses that combine component carriers to transmit, but the invention is not limited thereto, and in uplink of a mobile station apparatus, the phase rotation sections described previously are applicable to transmission processing of the mobile station apparatus.

Further, in the descriptions of above-mentioned Embodiments 1 to 5, the phase rotation amount is calculated and determined based on the physical cell ID, which is equivalent to determining the phase rotation amount based on a signal waveform in transmitting a reference signal, primary synchronization channel, secondary synchronization channel, or broadcast information channel that is determined based on the physical cell ID.

### DESCRIPTION OF SYMBOLS

100, 200, 300, 400 Base station apparatus
101-1˜101-n Coding section
102-1˜102-n Modulation section
103-1˜103-n SCH/RS generating section
104-1˜104-n Multiplexing section
105-1˜105-n Phase rotation section
106 Component carrier multiplexing section
107 Frequency/time transform section
108 Transmission section
110 Reception section
111-1˜111-n Demodulation section
112-1˜112-n Decoding section
113 Control section
114 Physical cell ID/phase rotation amount correspondence table
115 Upper layer
116 CM calculating section
401 physical cell ID/phase rotation offset amount correspondence table
402 Physical cell ID/phase rotation amount correspondence table
403 counter
500 Reception processing section
501 Reception section
502 Synchronization processing section
503 Time/frequency transform section
504 Component carrier dividing section
505-1˜505-n Phase rotation section
506-1˜506-n Propagation path compensation section
507-1˜507-n Demodulation section
508-1˜508-n Decoding section
509 Upper layer
510 Control section
511 Physical cell ID/phase rotation amount correspondence table
512 Physical cell ID/phase rotation offset amount correspondence table
513 Counter
1200 Reception processing section
1201 Reception section
1202 Synchronization processing section
1203 Time/frequency transform section
1204 Component carrier dividing section
1205-1˜1205-n Phase rotation section
1206-1˜1206-n Propagation path compensation section
1207-1˜1207-n Demodulation section
1208-1˜1208-n Decoding section
1209 Upper layer
1210 Control section
1211 Phase difference calculating section
1212 Phase difference determining section

1. A base station apparatus that combines a plurality of component carriers to transmit, comprising:
a phase rotation section that provides phase rotation for each component carrier; and
a transmission section that transmits the component carrier provided with the phase rotation to a mobile station apparatus,
wherein an amount of the phase rotation is determined based on a physical cell ID common to component carriers.

2. The base station apparatus according to claim 1, further comprising:
a physical cell ID/phase rotation amount correspondence table that associates an amount of phase rotation which is beforehand set based on a CM (Cubic Metric) value with the physical cell ID,
wherein the phase rotation section provides phase rotation for each component carrier based on the physical cell ID/phase rotation amount correspondence table.

3. The base station apparatus according to claim 1, wherein the phase rotation section has a sign inverting section that inverts a sign, and a replacing section that replaces a real part and an imaginary part of an input signal with each other.

4. A base station apparatus that combines a plurality of component carriers to transmit, comprising:
a phase rotation section that provides phase rotation for each component carrier;
a CM calculating section that calculates a CM value when a physical cell ID is changed in any one of the component carriers;
a control section that sets the phase rotation section for an amount of phase rotation based on the CM value; and
a transmission section that transmits the component carrier provided with the phase rotation to a mobile station apparatus.

5. The base station apparatus according to claim 2, wherein the CM value is a value when a transmission signal is a reference signal of each component carrier, a primary synchronization channel, a secondary synchronization channel, a broadcast information channel or a combination thereof.

6. A base station apparatus that combines a plurality of component carriers to transmit, comprising:
a phase rotation section that provides phase rotation for each component carrier; and
a transmission section that transmits the component carrier provided with the phase rotation to a mobile station apparatus,
wherein an amount of the phase rotation is determined based on a physical cell ID, while being changed based on the physical cell ID at certain time intervals.

7. The base station apparatus according to claim 6, further comprising:
a physical cell ID/phase rotation amount correspondence table that associates the physical cell ID with each amount of phase rotation of the component carrier; and
a physical cell ID/phase rotation offset amount correspondence table that associates the physical cell ID with a phase rotation offset amount in the time domain to store,
wherein the phase rotation section provides phase rotation for each component carrier based on the physical cell ID/phase rotation amount correspondence table and the physical cell ID/phase rotation offset amount correspondence table.

8. The base station apparatus according to claim 1, wherein the base station apparatus changes a basis for the amount of the phase rotation corresponding to the number of component carriers to combine.

9. A mobile station apparatus that performs wireless communications with the base station apparatus according to claim 1,
wherein the mobile station apparatus provides a signal received from the base station apparatus with inverse phase rotation to phase rotation provided in the base station apparatus.

10. The mobile station apparatus according to claim 9, wherein the mobile station apparatus provides the inverse phase rotation based on an amount of phase rotation that is beforehand notified from the base station apparatus using an upper control signal.

11. The mobile station apparatus according to claim 9, further comprising:
a phase difference determining section that determines an amount of phase rotation of each component carrier from a phase difference between adjacent component carriers,
wherein the mobile station apparatus provides the inverse phase rotation based on the amount of phase rotation determined in the phase difference determining section.

12. A mobile station apparatus that performs wireless communications with the base station apparatus according to claim 2, comprising:
a physical cell ID/phase rotation amount correspondence table that associates an amount of phase rotation that is beforehand set based on a CM value with the physical cell ID,
wherein the mobile station apparatus acquires an amount of phase rotation from the physical cell ID/phase rotation amount correspondence table, and a physical cell ID of a base station apparatus to connect, and provides a signal received from the base station apparatus with inverse phase rotation to phase rotation provided in the base station apparatus.

13. A mobile station apparatus that performs wireless communications with the base station apparatus according to claim 8,
wherein the mobile station apparatus provides a signal received from the base station apparatus with inverse phase rotation to phase rotation provided in the base station apparatus on a basis for an amount of phase rotation corresponding to the number of combined component carriers.

14. A mobile communication system comprising:
the base station apparatus according to claim 1;
a mobile station apparatus supporting EUTRA (Evolved Universal Terrestrial Radio Access); and
a mobile station apparatus supporting A-EUTRA (Advanced EUTRA).

15. The base station apparatus according to claim 4, wherein the CM value is a value when a transmission signal is a reference signal of each component carrier, a primary synchronization channel, a secondary synchronization channel, a broadcast information channel or a combination thereof.

16. A mobile communication system comprising:
the base station apparatus according to claim 4;
a mobile station apparatus supporting EUTRA (Evolved Universal Terrestrial Radio Access); and
a mobile station apparatus supporting A-EUTRA (Advanced EUTRA).

17. A mobile communication system comprising:
the base station apparatus according to claim 6;
a mobile station apparatus supporting EUTRA (Evolved Universal Terrestrial Radio Access); and
a mobile station apparatus supporting A-EUTRA (Advanced EUTRA).
